(19) United States
(12) Patent Application Publication
(10) Pub. No.: US 2015/0193103 A1
(43) Pub. Date: Jul. 9, 2015

(54) USER TERMINAL APPARATUS AND CONTROL METHOD THEREOF

(71) Applicant: SAMSUNG ELECTRONICS CO., LTD., Suwon-si (KR)

(72) Inventors: Ji-bum MOON, Seoul (KR); Young-ah LEE, Seoul (KR); Kwan-min LEE, Seoul (KR); Jean-Christophe NAOUR, Anyang-si (KR)

(73) Assignee: SAMSUNG ELECTRONICS CO., LTD., Suwon-si (KR)

(21) Appl. No.: 14/466,507

(22) Filed: Aug. 22, 2014

(30) Foreign Application Priority Data
Jan. 6, 2014 (KR) 10-2014-0001459

(51) Int. Cl. G06F 3/0484; G06F 3/16

(52) U.S. Cl. CPC G06F 3/0484; G06F 3/165

(57) ABSTRACT

A user terminal apparatus includes a user interface (UI) including a physical guide to guide a user interaction regarding the UI, and a controller configured to provide a UI screen which corresponds to a modified context based on the physical guide in response to a context of an external apparatus being modified, and transmit a signal to the external apparatus to control the external apparatus in response to a touch interaction being input through the physical guide.

### CROSS-REFERENCE TO RELATED APPLICATIONS

[1] This application claims priority from Korean Patent Application No. 10-2014-0001459, filed on Jan. 6, 2014 in the Korean Intellectual Property Office, the disclosure of which is incorporated herein by reference in its entirety.

### BACKGROUND

1. Field

Devices and methods consistent with what is disclosed herein relate to a user terminal apparatus and a control method thereof. In particular, exemplary embodiments relate, to a user terminal device provided with a remote controlling function and a control method thereof.

2. Description of the Related Art

Various types of display apparatuses are being developed. In particular, display apparatuses such as TVs, PCs, laptop computers, tablet PCs, mobile phones, or MP3 players have a sufficiently high supply ratio to be used by most of the general public.

In order to meet user needs for requesting newer and more functions, efforts have been recently made to develop a new type of a display apparatus.

In order to meet the user needs, user terminal apparatuses of the related art may be developed with a touch screen that can variously modify inputting layouts used in various fields.

However, the related art user terminal apparatus has a problem in that a user needs to check the screen and input manipulation.

### SUMMARY

Exemplary embodiments may overcome the above disadvantages and other disadvantages not described above. Also, the exemplary embodiments are not required to overcome the disadvantages described above, and an exemplary embodiment may not overcome any of the problems described above.

According to an exemplary embodiment, a user terminal apparatus may be provided with a user interface in which a user can input a command that he wants only with tactile feelings based on a physical guide to guide user interaction, and a control method thereof.

An aspect of an exemplary embodiment may provide a user terminal apparatus which may include a user interface (UI) which includes a physical guide which guides a user interaction regarding the UI, and a controller configured to provide a UI screen which corresponds to a modified context based on the physical guide in response to a context of an external apparatus being modified, and transmit a signal to the external apparatus to control the external apparatus in response to a touch interaction being input through the physical guide.

The context of the external apparatus may be at least one of a contents type displayed on the external apparatus, a plurality of functions provided from the external apparatus, and a display status of the external apparatus.

The user interface may include a touch screen, and the physical guide is provided on a touch screen.

The controller may be further configured to display a plurality of UI components which correspond to a plurality of functions controlled through the touch interaction, on an area which corresponds to the physical guide based on the context of the external apparatus.

The controller may be further configured to display the UI components to control at least one of a plurality of first functions which correspond to a first display status on the area which corresponds to the physical guide in response to the external apparatus operating in the first display status, and display the UI components to control at least one of a plurality of second functions which correspond to a second display status on the area which corresponds to the physical guide in response to the external apparatus operating in the second display status.

The physical guide may be provided in a format having a preset orientation, and the controller may be further configured to display the UI components to control the functions having a plurality of directional attributes which match with the preset orientation of the physical guide on the area which corresponds to the physical guide based on the context of the external apparatus.

The physical guide may be provided in a format which includes at least one protruded line with a preset orientation.

The controller may be further configured to display at least one of a UI for zapping channels and a UI for adjusting a volume on an area which corresponds to the physical guide in response to the external apparatus receiving broadcasting contents, and transmit at least one of a plurality of channel zapping signals and a plurality of volume adjusting signals which correspond to a touch interaction status in response to the touch interaction being input through the physical guide.

The controller may be further configured to transmit to the external apparatus a plurality of controlling signals which include at least one of a signal to convert a plurality of UI pages based on the context of the external apparatus, a signal to move an object, a signal to adjust a volume, a signal for zapping channels, a signal for scrolling manipulation, and a signal which indicates a progression on a progress bar.

The controller may be further configured to provide the UI screen which corresponds to the modified context of the external apparatus based on at least one of received information from the external apparatus and received information from an external server.

The controller may be further configured to provide the UI screen which corresponds to the modified context of the external apparatus based on information input through the user interface.

The controller may be further configured to provide a controlling mode of a horizontal status according to the context of the external apparatus, modify a plurality of directions of items in the UI screen so as to correspond to the controlling mode of the horizontal status, and display the items.

The controller may be further configured to control the user terminal apparatus so that a wallpaper screen is provided which includes at least one widget, a plurality of idle applications, and a plurality of customized contents, in response to the user terminal apparatus operating in a stand-by mode, and an initial screen is provided which includes a plurality of preset items, in response to a preset event.

The controller may be further configured to display the initial screen which includes the preset items in response to the preset event occurring in the stand-by mode, and transmit a signal to the external apparatus to provide a screen which corresponds to the preset items along with a signal to turn on the external apparatus in response to the preset items being selected.

The user terminal apparatus may additionally include a support protruding from at least one direction from a lower side of the user terminal apparatus, and the support may be used as a mount. The support may include a near field communication tag storing software module related to a remote controlling function, the support being separated from the user terminal apparatus, and the support automatically activating the remote controlling function of another user terminal apparatus in response to the support being attached to the another user terminal apparatus.

An aspect of an exemplary embodiment may provide a control method of a user terminal apparatus which may include displaying a user interface (UI) screen to control an external apparatus, providing a UI screen which corresponds to a modified context based on a physical guide to guide a user interaction regarding the UI screen in response to a context of the external apparatus being modified, and transmitting a signal to the external apparatus to control the external apparatus in response to a touch interaction being input through the physical guide.

The context of the external apparatus may be at least one of a contents type displayed on the external apparatus, a plurality of functions provided from the external apparatus, and a display status of the external apparatus.

The providing the UI screen which corresponds to the modified context may include displaying a plurality of UI components which correspond to a plurality of functions controlled through the touch interaction, on an area which corresponds to the physical guide based on the context of the external apparatus.

The providing the UI screen which corresponds to the modified context may include displaying the UI components to control at least one of a plurality of first functions which correspond to a first display status on the area which corresponds to the physical guide in response to the external apparatus operating in the first display status, and displaying the UI components to control at least one of a plurality of second functions which correspond to the second display status on the area which corresponds to the physical guide in response to the external apparatus operating in the second display status.

The physical guide may be provided in a format having a preset orientation, and the displaying the UI components may include displaying the UI components to control the functions having a plurality of directional attributes which match with the preset orientation of the physical guide on an area which corresponds to the physical guide based on the context of the external apparatus.

The physical guide may be provided in a format which includes at least one protruded line with a preset orientation.

The providing the UI screen which corresponds to the modified context may include displaying at least one of a UI for zapping channels and a UI for adjusting a volume on an area which corresponds to the physical guide in response to the external apparatus receiving broadcasting contents, and the transmitting the signal to the external apparatus may include transmitting at least one of a plurality of channel zapping signals and a plurality of volume adjusting signals which correspond to a touch interaction status in response to the touch interaction being input through the physical guide.

The transmitting the signal to the external apparatus includes transmitting to the external apparatus a plurality of controlling signals which may include at least one of a signal to convert a plurality of UI pages based on the context of the external apparatus, a signal to move an object, a signal to adjust a volume; signal for zapping channels, a signal for scrolling manipulation, and a signal which indicates a progression on a progress bar.

The providing the UI screen which corresponds to the modified context may additionally include providing the UI screen which corresponds to the modified context of the external apparatus based on at least one of received information from the external apparatus and received information from an external server.

The control method may additionally include providing a wallpaper screen which includes at least one widget, a plurality of idle applications, and a plurality of customized contents, in response to the user terminal apparatus operating in a stand-by mode, and providing an initial screen which includes a plurality of preset items, in response to a preset event.

The control method may additionally include displaying the initial screen which includes the preset items in response to the preset event occurring in the stand-by mode, and transmitting a signal to provide a screen which corresponds to the preset items along with a signal to turn on the external apparatus in response to the preset items being selected.

An aspect of an exemplary embodiment may provide an electronic system which may include an external apparatus, and a user terminal apparatus configured to provide a UI screen to control the external apparatus, and which includes a physical guide which guides a user interaction regarding the UI screen. The user terminal apparatus may be configured to provide the UI screen which corresponds to a modified context based on the physical guide in response to a context of the external apparatus being modified, and may transmit a signal to the external apparatus to control the external apparatus in response to a touch interaction being input through the physical guide.

An aspect of any exemplary embodiment may provide a control method of a user terminal apparatus including connecting the user terminal apparatus with an electronic apparatus, displaying a user interface (UI) screen on the user terminal apparatus to control the electronic apparatus in response to the user terminal apparatus being connected with the electronic apparatus, displaying the UI screen on the electronic apparatus in response to the UI screen being displayed on the user terminal apparatus, receiving a touch interaction in a touch mode on the UI screen on the user terminal apparatus in response to the touch mode being set, and transmitting information to the electronic apparatus which corresponds to the touch interaction on the UI screen on the user terminal apparatus in response to the touch interaction being received, and performing at least one function on the displayed UI screen on the electronic apparatus in response to the information being received at the electronic apparatus.

According to the exemplary embodiments, user convenience is enhanced because a user can input commands using tactile feelings without having to check or verify the screen.

User convenience is enhanced because a user interface (UI) screen corresponding to a real-time status can be provided to the external apparatus based on the physical guide provided to guide user interaction.

### BRIEF DESCRIPTION OF THE DRAWINGS

The above and/or other aspects of the exemplary embodiments will be more apparent by describing certain exemplary embodiments with reference to the accompanying drawings, in which:

FIGS. 1A and 1B is a view provided to explain a display system according to an embodiment;

FIGS. 2A and 2B are block diagrams of a user terminal apparatus according to various embodiments;

FIG. 2C is a block diagram of an electronic apparatus according to an embodiment;

FIG. 3 is a view provided to explain various software modules stored in a storage according to an embodiment;

FIGS. 4A to 4D are views provided to explain structure of the user terminal apparatus according to an embodiment;

FIGS. 5A to 5D are views provided to explain operation of the user terminal apparatus according to an embodiment;

FIGS. 6A to 6D are views provided to explain operation of the user terminal apparatus according to another embodiment;

FIGS. 7A to 13C are views provided to explain operation of the user terminal apparatus according to another embodiment;

FIGS. 14A to 14B are views provided to explain a navigation control method according to another embodiment;

FIGS. 15A to 15B are views provided to explain a control method of an external apparatus according to another embodiment;

FIGS. 16A to 16C illustrate formats of a physical guide according to various embodiments; and

FIGS. 17A to 17B are views provided to explain a function of a support according to another embodiment.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Accordingly, it is apparent that the exemplary embodiments can be carried out without those specifically defined matters. Also, well-known functions or constructions are not described in detail since they would obscure the exemplary embodiments with unnecessary detail.

Referring to the attached drawings, the exemplary embodiments will be described in detail below.

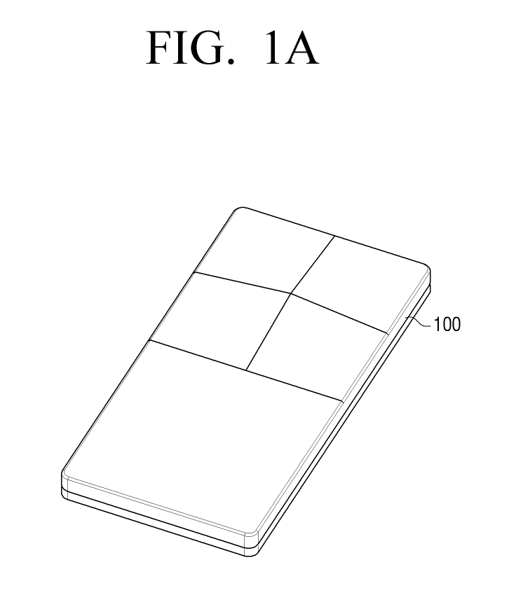

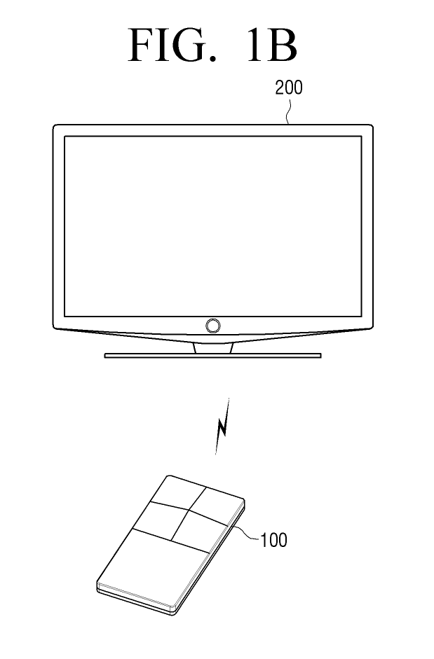

FIG. 1A is a view provided to explain a user terminal apparatus according to an embodiment.

The user terminal apparatus 100 may be implemented in various forms such as mobile phones, portable music players (PMPs), personal digital assistant (PDAs), or laptop computers that can be carried around.

In particular, the user terminal apparatus 100 may be implemented to be a touch-based mobile terminal type in which UI screens are displayed and the displayed UI screens are controllable according to touch interaction. In this case, the user terminal apparatus 100 may be implemented to include a touch screen. Therefore, the user terminal apparatus 100 may be implemented to run programs with a finger or a pen (e.g., stylus pen) with use of an embedded touch sensor. The user terminal apparatus 100 may be implemented with a touch sensor or an optical joystick (OJ) sensor which applies the optical technology in order to receive the inputting various types of user commands.

Further, the user terminal apparatus 100 may be implemented to include a physical guide to guide user interaction regarding UI screens. Thus, the physical guide performs the guiding so that a user can input user interaction that he wants only by tactile feelings. Herein, the physical guide may be in a format including at least one projected line having the orientation. For example, the physical guide can be formed in a cross-shape protrusion, but is not limited thereto. The physical guide may be formed in various shapes such as diagonal lines, crossed diagonal lines, curves, circles, ovals, rectangles, and triangles. However, for convenient explanation, the following description will assume that the physical guide may be cross-shape.

In this case, the user terminal apparatus 100 may sense touch interaction regarding the physical guide, generate signals corresponding to the touch interaction, and control functions of the user terminal apparatus 100 according to corresponding signals. In particular, the user terminal apparatus 100 may generate direction signals corresponding to a direction of touch interaction, and control corresponding functions of the user terminal apparatus 100 according to the direction signals. For example, according to upper direction signals generated by the touch interaction in an upper direction, the user terminal apparatus 100 may perform functions such as volume-up.

FIG. 1B is a view provided to explain a display system according to an exemplary embodiment.

Referring to FIG. 1B, the display system according to an exemplary embodiment includes the user terminal apparatus 100 and an electronic apparatus 200.

The user terminal apparatus 100 illustrated in FIG. 1A may be implemented as a remote controlling apparatus to control the electronic apparatus 200.

In this case, the user terminal apparatus 100 performs functions of providing a user interface (UI) screens on the touch screen to control the electronic apparatus 200, and transmitting corresponding signal to user touch interaction inputted through corresponding UI screens to the electronic apparatus 200.

In particular, the user terminal apparatus 100 may provide UI screens corresponding to the context of the electronic apparatus 200, and provide UI screens corresponding to the modified context when a display status of the electronic apparatus 200 is modified. The context of the electronic apparatus 200 indicates a status in which controlling is requested, and includes various situations and status such as functions provided on the electronic apparatus, provided contents types, provided image panels, and display statuses.

Further, the user terminal apparatus 100 may display UI components comprising UI screens corresponding to the modified context based on the above physical guide.

Further, the user terminal apparatus 100 may generate corresponding signals by sensing a touch interaction regarding the physical guide, and control functions of the electronic apparatus 200 by transmitting corresponding signal to the electronic apparatus 200. In particular, the user terminal apparatus 100 may generate signals corresponding to a touch interaction situation, and control corresponding functions of the electronic apparatus 200 by transmitting the generated signal to the electronic apparatus 200. For example, according to upper direction signals generated by an upper directed touch interaction in an upward direction, functions such as volume-up may be performed in the electronic apparatus 200.

As illustrated in FIG. 1B, the electronic apparatus 200 may be implemented to be a digital TV, but not limited thereto. The electronic apparatus 200 may be implemented to be various types of apparatuses provided with display functions such as a personal computer (PC), navigation, kiosk, and digital information display (DID). Accordingly, the electronic apparatus 200 may be implemented as an apparatus excluding display functions when the electronic apparatus 200 can be controlled by the user terminal apparatus 100.

The electronic apparatus 200 may receive signals corresponding to the user touch interaction inputted through the user terminal apparatus 100, and may be controlled according to the received signals. In particular, the electronic apparatus 200 may provide various screens according to the received signals from the user terminal apparatus 100.

Further, the electronic apparatus 200 may transmit corresponding signal to display statuses to the user terminal apparatus 100. In this case, the user terminal apparatus 100 may provide UI screens corresponding to the display statuses of the electronic apparatus 200.

The following will further explain constitutions of the user terminal apparatus 100 and the electronic apparatus 200 by referring to the drawings below.

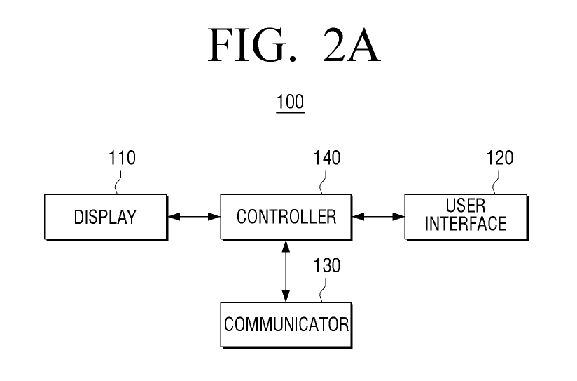

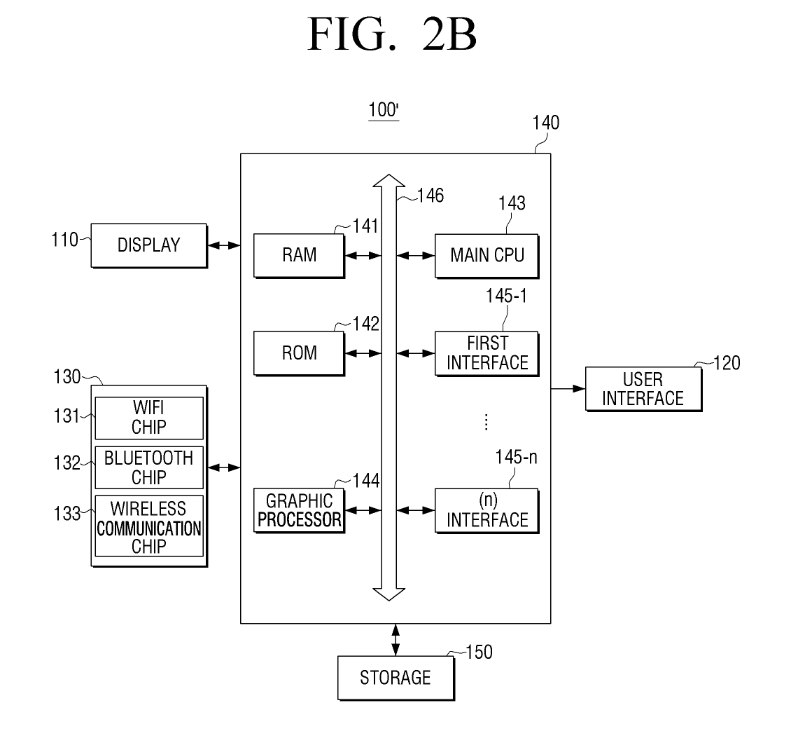

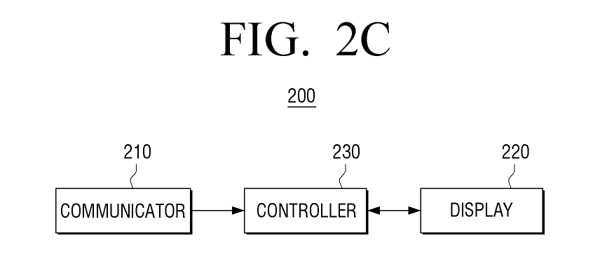

FIGS. 2A and 2B are block diagrams of a user terminal apparatus according to various embodiments.

FIG. 2A is a block diagram of a user terminal apparatus according to an exemplary embodiment.

In FIG. 2A, the user terminal apparatus 100 includes a display 110, a user interface 120, a communicator 130, and a controller 140.

Displayed Information

The display 110 displays various UI screens.

In particular, when the user terminal apparatus 100 may be a remote controlling apparatus to control the external electronic apparatus 200, the display 110 may provide various UI screens to control functions of the electronic apparatus 200. For example, the display 110 may provide a menu screen to select various functions that can be provided from the electronic apparatus 200, and a UI screen to select various modes. UI screens may include various contents playing screens such as image, video, text, and music, application implementing screens including various contents, web browser screens, and graphical user interface (GUI) screens. For example, when the electronic apparatus 200 may be digital TV, the display 110 may provide a UI screen for zapping channels, a UI screen for adjusting the volume, a UI screen for selecting contents, and a UI screen for selecting applications. In an exemplary embodiment, the UI screen for zapping channels may be used for quickly changing channels or channel surfing through a plurality of channels.

The display 110 may be implemented as a liquid crystal display panel (LCD) or organic light emitting diodes (OLED), but is not limited thereto. The display 110 may be also implemented to be a flexible display and a transparent display.

Constitution of User Interface

The user interface 120 performs a function of receiving the inputting various user commands.

In particular, when the user terminal apparatus 100 may be a remote controlling apparatus to control the electronic apparatus 200, the user interface 120 may receive the inputting various user commands to control functions of the electronic apparatus 200.

The user interface 120 may receive the various incoming user commands through various UI screens to control functions of the electronic apparatus 200, which are provided through the display 110. In this case, the user interface 120 may be implemented to be a touch screen type which constitutes an interlayer structure with a touch pad. Therefore, the user interface 120 may be used as the display 110.

Further, the user interface 120 may include the physical guide formed on the touch screen. The physical guide may be formed in various shapes. In particular, the physical guide may be formed in a cross-shape of a down-tilting format toward surrounding directions from the center of the cross.

The user interface 120 may receive a user touch interaction regarding at least one of an upper-and-lower direction and a left-and-right direction based on the shape of the physical guide. Therefore, a user may recognize shape of inputted manipulation only with tactile feelings even when the user does not view the user terminal apparatus 100. The physical guide may be referred to as a fiddle because it may provide tactile feelings such as strings of string instruments.

The touch screen may be formed on whole area of the display 110, and the physical guide may be formed on a part of the area on the display 110. For example, the physical guide may be provided on the upper area of the display 110. Therefore, the lower area of the display 110 may be provided only with the touch screen.

User interaction input through the physical guide may be recognized as various user commands according to at least one among a status regarding the electronic apparatus 200 and UI types provided to the display 110. For example, when the physical guide may be cross-shape, user interaction dragging from the center of the cross toward the upper direction may be recognized as a user command to adjust channel numbers when the electronic apparatus 200 is operating in a channel zapping situation (e.g., channel searching), and a user command to turn up the volume when the electronic apparatus 200 is operating in volume adjusting situation.

However, shapes of the physical guide are not limited to the cross-shape, and various shapes may be provided. For example, the physical guide may be implemented to various shapes such as diagonal types, crossed diagonal types of protrusions, curved types, parallel types in which more than two protrusions are provided in parallel with at least one of protrusions toward a left-and-right direction and an upper-and-lower direction, or outer types in which an outer area additionally includes protrusions.

Further, according to cases, the user terminal apparatus 100 may be implemented to be a layered format of two panels so as to perform the sliding manipulation of the upper panel toward at least one direction among upper, lower, left, and right directions based on the lower panel among the layered panels. Further, it may be implemented so that the structure can receive the inputting user commands as a user interface 120.

Interoperating with Electronic Apparatus and User Terminal Apparatus

The communicator 130 performs communication with the electronic apparatus 200. The communicator 130 may perform communication with the electronic apparatus 200 or an external server (not illustrated) thorough various communication methods such as Bluetooth (BT), wireless fidelity (WI-FI), Zigbee, infrared (IR), Serial Interface, universal serial bus (USB), and near field communication (NFC).

In particular, in response to a preset event, the communicator 130 may be working in an interoperated status by performing communication with the electronic apparatus 200 according to a predefined communication method. Interoperating may indicate every status in which communication can be available such as an operation to initialize communication between the user terminal apparatus 100 and the electronic apparatus 200, an operation to build the network, and an operation to perform the device pairing. For example, device identifying information of the user terminal apparatus 100 may be provided to the electronic apparatus 200, and the pairing process between the two apparatuses may be performed according to the information. For example, in response to a preset event occurring in the user terminal apparatus 100, surrounded devices may be searched through Digital Living Network Alliance (DLNA) technology, and an interoperating status may be provided by performing the pairing with the searched devices.

A preset event may occur among at least one of the user terminal apparatus 100 and the electronic apparatus 200. For example, a user command to select the electronic apparatus to be controlled device may be input from the user terminal apparatus 100, or electrical power of the electronic apparatus 200 may be turned on.

Information Received from Electronic Apparatus

When the user terminal apparatus 100 interoperates with the electronic apparatus 200, the communicator 130 may transmit a corresponding signal to the input user commands from the user interface 120 to the electronic apparatus 200, or receive various status information from the display apparatus 100.

In particular, the communicator 130 may receive various status information from the electronic apparatus 200 regarding cases in which the electronic apparatus 200 enters at least one mode among broadcasting view mode to view broadcasting channels at real time, contents play mode to play VOD contents, menu provide mode to provide a preset menu, game mode to play games, and web mode to provide web browsers, operates in corresponding mode, and exits from corresponding mode.

Further, even if the electronic apparatus 200 is operating in specific mode, the communicator 130 may receive information regarding corresponding sub function from the electronic apparatus 200 when a sub function provided form specific mode is performed. For example, when the electronic apparatus 200 is adjusting the volume or requesting the volume-adjusting in the broadcasting view mode, corresponding status information may be received from the electronic apparatus 200. For example, when the electronic apparatus 200 is operating in mute situation, the communicator 130 may receive corresponding status information.

Information Received from External Server

Further, the communicator 130 may perform communication with an external server (not illustrated) according to cases.

In particular, the communicator 130 may receive information corresponding to the status of the electronic apparatus 200, information regarding UI screens corresponding to the status of the electronic apparatus 200, controlling information corresponding to the UI information, and various information provided through the display 110 from an external server (not illustrated). For example, when social network services (SNS) screens are provided form the user terminal apparatus 100 according to a user command, corresponding information may be received from an external server (not illustrated).

An external server (not illustrated) may update information regarding the user terminal apparatus 100 and the electronic apparatus 200 by connecting the internet through network. For example, it may update device driver information, controlling information, and UI information.

Stand-by Mode

The controller 140 controls a general operation of the user terminal apparatus 100.

The controller 140 operates in wallpaper mode which displays contents such as widgets, idle applications, pictures, and animation while operating in stand-by mode. The stand-by mode indicates stand-by screen of devices such as mobile phone and status in which working is not performed.

In particular, the controller 140 may display widgets such as clock, weather, and calendar, or provide idle applications such as alarm, speed dial, my menu, and music player in the stand-by mode.

Further, the controller 140 may provide contents customized by a user in the stand-by mode. The contents customized by a user may be contents such as family pictures.

Further, the controller 140 may modify and display wallpaper contents provided in the stand-by mode according to a preset event. For example, when a preset time passes, the controller 140 may automatically modify and display wallpaper contents. When an event such as a message arriving or a memo receiving occurs, the controller 140 may modify wallpaper contents into corresponding event descriptions and display the event descriptions, or provide a reminder regarding corresponding message or memo.

Entering Initial Screen

The controller 140 may control displaying initial screen in response to a preset event.

In particular, the controller 140 may display an initial screen when user gripping is recognized. Gripping may be recognized through various sensors.

For example, the controller 140 may recognize the gripping and display an initial screen when a user touch is sensed through a touch sensor provided at least one of both side sections and back face of the user terminal apparatus 100.

For another example, the controller 140 may recognize the gripping and display an initial screen when at least one of rotating and tilting are sensed through at least one of a gyro sensor and an acceleration sensor provided in the user terminal apparatus 100.

The controller 140 may display an initial screen when a user approaching the user terminal apparatus 100 is sensed through a near field sensor.

The controller 140 may provide a shortcut menu regarding main categories provided from the electronic apparatus 200 and favorite categories, i.e., direct menu. In response to the shortcut menu performing a function in the user terminal apparatus 100, a corresponding function in a corresponding menu may be simultaneously performed when the electronic apparatus 200 is turned on. Further, when the shortcut menu is selected, the controller 140 may transmit a turning-on signal to turn on the electronic apparatus 200 as well as selecting signals regarding the corresponding menu to the electronic apparatus 200.

Therefore, the shortcut menu reduces a user inconvenience in which a corresponding menu should be selected (and is not currently selected) after the electronic apparatus 200 is turned on. For example, when video on demand (VOD) contents base category menu is selected while the electronic apparatus 200 is turned off, VOD contents category menu may be simultaneously selected when the electronic apparatus 200 is turned on.

For examples of the shortcut menu regarding main contents categories provided from the electronic apparatus 200, it may provide the shortcut menu regarding real-time TV view category, VOD contents base category, SNS contents share base category, application provide category, and personal contents category. However, it may not be limited. Further, for examples of the shortcut menu regarding favorite categories, it may provide previous view menu, current broadcasting menu, message menu, and input source menu. However, it may not be limited. The previous view menu may be implemented to include a thumbnail of VOD that is recently viewed, the screen at the time of finishing the viewing, webpage screen, and application information. When the screen at the time of finishing the viewing is provided, it may be implemented so that the view can directly start at a corresponding finishing time by selecting corresponding menu. Further, the web page screen may be implemented to directly provide a corresponding web page by storing images with URL information and transmitting URL information to the electronic apparatus according to selecting corresponding menu. Regarding the application, when the application is finished while being processed to specific depth, it may be implemented to directly provide corresponding screen to the depth at the finishing time.

Providing UI Screen

In particular, the controller 140 may provide corresponding UI to the display 110 based on the status information regarding the electronic apparatus 200 received through the communicator 130, or provide corresponding UI to the display 110 according to the user command inputted through the user interface 120.

In particular, the controller 140 may display UI components constituting UI screen corresponding to the context of the electronic apparatus 200 based on the physical guide. Further, the controller 140 may display UI components constituting the corresponding UI screen to the modified status based on the physical guide when the context of the electronic apparatus 200 is modified. For example, when the controller 140 receives status information in which the electronic apparatus 200 enters at least one of the broadcasting view mode, the contents play mode to play VOD contents, the menu provide mode, the game mode, and the web mode, or the electronic apparatus 200 is operating in corresponding mode, the controller 140 may provide corresponding UI screen regarding the mode to the display 110. Further, when the controller 140 receives status information in which the electronic apparatus 200 performs a sub function provided from specific mode while operating in specific mode, it may provide corresponding UI regarding the sub function to the display 110. For example, if the electronic apparatus 200 is operating in a mute situation, the controller 140 may provide UI to adjust the volume on the display 110 when receiving corresponding status information.

The controller 140 may display UI components that can be controlled through touch interaction on an area corresponding to the physical guide based on the display status of the electronic apparatus 200.

Further, the physical guide is formed to provide a preset orientation, and the controller 140 may display UI components that can control functions having directional attributes matched with the orientation of the physical guide on an area corresponding to the physical guide based on the display status of the electronic apparatus 200. For example, when the electronic apparatus 200 is operating in broadcasting receiving situation, and when the physical guide may be cross-shape, the controller 140 may display UI components for zapping channels (e.g., channel searching) on the left-and-right area of the cross-shape guide, and UI components for adjusting the volume on the upper-and-lower area of the cross-shape guide.

Controlling External Apparatus with Physical Guide

The controller 140 may modify status of the electronic apparatus 200 by transmitting a corresponding signal to the user commands input through the user interface 120 to the electronic apparatus 200.

In particular, the controller 140 may transmit corresponding direction signals regarding the touch direction to the electronic apparatus 200 when a user touch interaction regarding the physical guide is input. The direction signals may be at least one among a signal to convert UI pages, a signal to move an object, signal to adjust the volume, a signal to zap channels, a signal to scroll, and a signal to provide progression on a progress bar. However, exemplary embodiments are not limited thereto. In this case, the controller 140 may transmit the direction signal to the electronic apparatus 200, or controlling signals generated based on the direction signal to the electronic apparatus 200.

In particular, when the controller 140 transmits the direction signal to the electronic apparatus 200, the electronic apparatus 200 may generate controlling signals corresponding to the direction signals and control the electronic apparatus 200. For example, if the electronic apparatus 200 is operating in a volume adjusting situation, when the controller 140 transmits the upper direction signal to the electronic apparatus 200, the electronic apparatus 200 may generate the controlling signal to turn up the volume and control the electronic apparatus 200 according to the generated controlling signals.

Further, the controller 140 may generate controlling signals corresponding to the direction signals based on at least one among status information of the electronic apparatus 200 and UI types provided to the display 110, and transmit the controlling signal to the electronic apparatus 200. For example, the controller 140 may generate the controlling signal to turn up the volume of the electronic apparatus 200 and transmit the controlling signal to the electronic apparatus 200 when the upper directed touch interaction is sensed from the physical guide while the volume adjusting UI is provided to the display 110.

According to cases, when a user touch regarding one direction of the physical guide is performed, the controller 140 may transmit direction signals corresponding to a first function of the electronic apparatus 200 to the electronic apparatus 200. When user touch regarding another direction of the physical guide is performed, the controller 140 may transmit direction signals corresponding to a second function of the electronic apparatus 200 to the electronic apparatus 200.

For example, if the physical guide may be cross-shape guide, when a user touch to drag the physical guide toward upper and lower directions is performed, the controller 140 may transmit a volume adjusting signal to the electronic apparatus 200. When user touch to drag the physical guide toward left and right directions is performed, the controller 140 may transmit a channel zapping signal to the electronic apparatus 200. In this case, the controller 140 may provide UI regarding functions controlled respectively with each direction among upper, lower, left and right directions. For example, the controller 140 may provide a UI to adjust the volume toward the upper-and-lower direction of the physical guide, and a UI to zap channels toward the left-and-right direction.

Further, when a specific item is selected on the UI screen provided through the display 110, the controller 140 may transmit a corresponding selecting signal to the electronic apparatus 200, or provide a corresponding screen to the selecting signals on the display 110. Items may include various information such as contents provider information, contents information, service provider information, service information, application running information, contents playing information, and user information. Further, provided information may be displayed in various components such as text, file, image, video, icon, button, menu and dimensional icon. For example, contents provider information may be provided in formats such as icons or logos which represent corresponding contents providers, and contents information may be provided in a thumbnail format. Further, user information may be provided in profile images of users. A thumbnail may be provided by decoding additional information provided from original contents and converting the additional information thumbnail size. When there is no additional information, original contents may be decoded and converted into thumbnail size. Therefore, the reduced type of thumbnail images may be extracted and provided. Original contents may be still images or video formats. When original contents are video formats, the original contents may generate thumbnail images in an animation image format with a plurality of still images.

Various User Interaction According to Display Apparatus Status

The controller 140 may display a UI for zapping broadcasting channels on the touch screen when the electronic apparatus 200 enters the broadcasting receive mode. Further, when a user touch is performed regarding the physical guide, the controller 140 may transmit a direction signal for zapping channels (e.g. channel searching) corresponding to the touch direction to the electronic apparatus 200. For example, the physical guide on the touch screen may provide a UI indicating a currently selected channel number, a previous channel number, and a next channel number.

When specific broadcasting channel is selected in the electronic apparatus 200, the controller 140 may display a UI for adjusting the volume on the touch screen. When user touch is performed regarding the physical guide, the controller 140 may transmit a direction signal for adjusting the volume corresponding to the touch direction to the electronic apparatus 200. For example, the physical guide on the touch screen may provide a UI indicating a volume adjusting situation.

Further, when the electronic apparatus 200 enters the menu select mode, the controller 140 may display a UI for selecting a menu on the touch screen. When user touch is performed regarding the physical guide, the controller 140 may transmit the direction signal to move the selecting GUI corresponding to the touch direction to the electronic apparatus 200. For example, the physical guide on the touch screen may provide the UI indicating four directional keys to move the selecting GUI.

Further, when the electronic apparatus 200 enters the character input mode, the controller 140 may display a UI for inputting characters on the touch screen. When characters are inputted through UI for inputting characters, the controller 140 may transmit signals corresponding to the inputted characters to the electronic apparatus 200.

Mode of User Terminal Apparatus

The controller 140 may provide a UI screen according to one mode among the vertical mode and the horizontal mode according to a status of the electronic apparatus 200.

In particular, when the electronic apparatus 200 is based on a context, i.e., when the electronic apparatus 200 is operating in a status that can be easily controlled on the horizontal mode of the user terminal apparatus 100, the controller 140 may provide a UI corresponding to the horizontal mode. The controller 140 may modify and display directions of items included in UI screen so as to correspond to controlling the horizontal mode.

For example, when web pages are provided on the electronic apparatus 200, the user terminal apparatus 100 may be used in the horizontal mode. Therefore, the area provided with the physical guide receives the inputting scroll manipulating commands through the physical guide, and the touch screen area without the physical guide receives the inputting user commands to adjust cursor positions. In another example, when a preset game is running on the electronic apparatus 200, direction manipulating commands may be input through the area provided with the physical guide and user commands to perform specific functions may be input through the touch screen area without the physical guide.

Providing Modifiable Physical Guide

The physical guide may be provided in a physical bar format. Accordingly, the physical guide may be provided in physical bar formats such as attached format like a sticker or a flexible material format.

When the physical guide is provided in the modifiable format, it may be modified into various shapes according to usage.

For example, when the physical guide is provided in the attached format like a sticker, various types of protrusions may be provided through various shapes of stickers. Further, the physical guide may be modified by providing different shapes of the physical guide. For example, when the display 110 of the user terminal apparatus 100 may be flexible display, the physical guide may be modified into various shapes according to usage, and provided.

In this case, various types of resonators may be provided through an actuator such as Electro Active Polymer (EAP), piezoelectric component, Shape Memory Alloy (SMA), thermal hydraulic pouch, Micro-Electro-Mechanical System (MEMS) component, MEMS pump and resonating device. For example, EAP may modify itself in response to approving the voltage. EAP may be constituted by using at least one of Electrostrictive Polymers (EP), Dielectric Elastomers (DE), conducting polymers, Ionic Polymer Metal Composites (IPMC), responsive gels, and bucky gels.

Providing Modification of Physical Guide and UI According to Usage

The controller 140 may provide at least one of the physical guide and UI screen in a corresponding format to the usage selected by a user regarding the user terminal apparatus 100.

For example, when usage of the user terminal apparatus 100 is controlling digital TV, the physical guide according to a first format may be provided. When usage of the user terminal apparatus 100 is established to be navigation controlling, the physical guide according to a second format may be provided.

Further, when usage of the user terminal apparatus 100 is controlling digital TV, a first UI screen may be provided on the physical guide. When usage of the user terminal apparatus 100 is controlling navigation, a second UI screen may be provided on the physical guide. Thus, even if formats of the physical guide are uniform, different UI screens may be provided on the physical guide according to usage.

Providing Modification of Protrusion and UI According to Position

The controller 140 may automatically provide at least one of the protrusion and UI screen in a corresponding format to a preset position of the user terminal apparatus 100. In this case, the user terminal apparatus 100 may further include Global Positioning System (GPS) receiver (not illustrated) that can receive GPS signals from GPS satellites and calculate current position of the user terminal apparatus 100. Thereby, the controller 140 may provide at least one of the protrusion and UI screen in a corresponding format based on current position information of the user terminal apparatus 100.

For example, when a current position of the user terminal apparatus 100 is determined to be a first place, e.g., home, the controller 140 may provide the physical guide in a format that can be used at home. When it is determined to be a second place, e.g., office, the controller 140 may provide the physical guide in a format that can be used at office. Further, formats of the physical guide according to positions may be previously established by a user. For example, a user may establish and store a format of the physical guide that can be easily used to control the digital TV at home, and a format of the physical guide that can be easily used to control a beam protrusion at office.

Further, even when a uniform format of the physical guide is provided in different places, the controller 140 may provide different Uls in formats which correspond to places on the physical guide.

Thereby, even when a user does not select a usage, it may automatically provide at least one of the physical guide and UI screen in corresponding formats to positions of the user terminal apparatus 100.

Control Function Regarding Other Electronic Apparatuses

The user terminal apparatus 100 may be applied in controlling various electronic apparatuses such as air conditioner, car, refrigerator, and washing machine, as well as display apparatuses such as digital TV.

In particular, the user terminal apparatus 100 may be used as a remote controlling device regarding each of various home devices described above, or used to control controlling screens regarding home devices provided on the display apparatuses such as digital TV.

For example, when the physical guide may be a cross-shape protrusion, the user terminal apparatus 100 may be implemented to adjust the temperature of the air conditioner through the provided upper-and-lower direction protrusion, and adjust the wind strength through the left-and-right direction protrusion.

For another example, when the digital TV is implemented to provide dimensional setting of devices at home, select and control home devices through corresponding dimensional setting, the user terminal apparatus 100 may be implemented to control home devices through the provided protrusion. In particular, when the refrigerator is selected to be controlled, the user terminal apparatus 100 may display a status providing screen in which currently included items in the refrigerator are scanned and displayed. In this case, the video displayed on the status providing screen may be obtained through a camera provided within the refrigerator. A user may adjust photographing directions of the camera included within the refrigerator at real time through the provided cross-shape protrusion, and confirm the items in the refrigerator. Therefore, a user can directly confirm necessary items without opening the refrigerator, and make an order online.

For another example, the cross-shape protrusion of the user terminal apparatus 100 may be used to adjust photographing directions of closed-circuit television (CCTV) to provide home security related screens.

Navigation Control

When the electronic apparatus 200 is a center fascia screen device of a car, e.g., navigation apparatus, the user terminal apparatus 100 may provide the touch mode to receive the inputting touch interaction so as to navigate menu items provided on a UI screen of the electronic apparatus 200. However, when the electronic apparatus 200 is a device to provide a UI that can be controlled with the input touch interaction from the user terminal apparatus 100 by connecting to the user terminal apparatus 100, the applying may be variously performed without being limited to the above.

In this case, the electronic apparatus 200 may receive corresponding information regarding the input touch interaction in the touch mode of the user terminal apparatus 100, and navigate menu items provided on UI screen according to the received information.

In particular, because a user can feel tilting of the physical guide provided in the user terminal apparatus 100 with his touch sense, he may navigate menu items provided on the UI screen of the navigation apparatus without viewing the user terminal apparatus 100.

Thereby, user convenience may be enhanced because the UI screen of the navigation apparatus can be controlled by performing touch interaction on the physical guide without performing touch interaction directly on the navigation apparatus and without viewing the user terminal apparatus 100.

Terminal Function

The physical guide may be used to control various functions provided from the user terminal apparatus 100, not to control the external apparatus 200 as remote controlling device.

In particular, when the user terminal apparatus 100 is a terminal apparatus performing specific functions such as a mobile phone, MP3, and PMP, the terminal apparatus may control functions provided from the user terminal apparatus 100 through the provided cross-shape protrusion.

For example, when the user terminal apparatus 100 provides the music player function, it may perform various manipulations related with the music player through the cross-shape protrusion. In particular, the user terminal apparatus 100 may be implemented to perform the adjusting the volume through touch interaction regarding the upper-and-lower direction protrusion, perform a function of playing previous and next songs through touch interaction regarding the left-and-right direction protrusion, and perform a function of pausing through touch interaction regarding the center of the cross-shape protrusion.

In another example, when the user terminal apparatus 100 provides the radio function, various manipulations related with the radio function may be performed through the cross-shape protrusion. In particular, the user terminal apparatus 100 may perform the adjusting the volume through touch interaction regarding the upper-and-lower direction protrusion, and perform the tuning the radio frequency through touch interaction regarding the left-and-right direction protrusion.

However, the above description is merely one of the exemplary embodiments. Functions that can be controlled by the protrusion may be variously modified.

Therefore, a user may control various functions provided from the user terminal apparatus 100 without directly viewing the user terminal apparatus 100.

Function of Support

The support (not illustrated) on the back face of the user terminal apparatus 100 may be provided in a protruded pyramid shape so as to hold an object that can be supported toward at least one direction on a supportable object such as table. Thus, a user can stand up the user terminal apparatus 100 on a table toward at least one direction among four supported directions through the pyramid protruded supporter.

Further, the support (not illustrated) may encourage gripping of a user because of the pyramid shape. For example, the plane shape of the user terminal apparatus may not encourage gripping the device; however, the pyramid shape of the support according to this invention may naturally encourage gripping the device.

Further, the support (not illustrated) may be implemented to be a back case cover that can be separated from the user terminal apparatus 100. When the support is combined with another user terminal apparatus (not illustrated), another user terminal apparatus (not illustrated) can provide the same function of the user terminal apparatus 100, e.g., the remote controlling function.

In this case, the support (not illustrated) may include near field communication tag (e.g., NFC tag) including software for the remote controlling function. When the support is attached with another user terminal apparatus, it may be implemented to automatically activate the remote controlling function. For example, when the support (not illustrated) is attached with another user terminal apparatus, another user terminal apparatus may provide the above initial screen because the remote controlling function is automatically activated through communication with the NFC tag. In this case, it may be implemented to provide tactile feelings according to the protrusion through a sticker including a protruded shape according to an exemplary embodiment.

The support (not illustrated) may provide various functions by modifying and storing software which is stored with TecTiles or any other near field communication application.

Therefore, in contrast to a method in which a loading process should be performed whenever downloading and implementing the remote controller application, the remote controlling function can be automatically activated with a simple method in response to the back case cover being attached.

FIG. 2B is a detailed block diagram of a user terminal apparatus according to another embodiment. Referring to FIG. 2B, the user terminal apparatus 100′ includes the display 110, the user interface 120, the communicator 130, the controller 140, the storage 150, and the sensor 160. The devices illustrated in FIG. 2 overlap in functionality with the devices of FIG. 1, and therefore will not be explained in detail.

The communicator 130 may perform communication with an external device, e.g., the external electronic apparatus 200 or an external server according to various types of communication methods described above.

The communicator 130 includes various communication chips such as a Wi-Fi chip 131, a Bluetooth chip 132, and a wireless communication chip 133. Wi-Fi chip 131 and Bluetooth chip 132 perform respective communication according to a Wi-Fi method and a Bluetooth method. The wireless communication chip 133 indicates a chip performing communication according to various communication standards such as IEEE, Zigbee, 3rd Generation (3G), 3rd Generation Partnership Project (3GPP), and Long Term Evolution (LTE). The communicator 130 may further include a NFC chip operating with a Near Field Communication (NFC) method.

The controller 140 controls a general operation of the user terminal apparatus 100′ using various programs stored in the storage 150.

In particular, the controller 140 may include a RAM 141, a ROM 142, a main CPU 143, a graphic processor 144, first to n interfaces (145-1˜145-n), and a bus 146.

RAM 141, ROM 142, the main CPU 143, the graphic processor 144, the first to n interfaces 145-1˜145-n may be connected with each other through the bus 146.

The first to n interfaces 145-1˜145-n may connect the above various devices. One of the interfaces may be network interface connecting the external apparatus through network.

The main CPU 143 performs the booting by accessing the storage 150 and using the stored operating system (0/S) in the storage 150. Further, the main CPU 143 performs various operations by using the stored various programs, contents and data in the storage 150.

ROM 142 stores a set of commands for booting the system. When a turn-on command is inputted and electrical power is provided, the main CPU 143 copies the stored O/S in the storage 150 to RAM 141 according to the stored command in ROM 142, and boots the system using the O/S. When the booting completes, the main CPU 143 copies various application programs stored in the storage 150 to RAM 141, and performs various operations by using the copied application programs in RAM 141.

The graphic processor 144 generates screens including various objects such as icons, images, and texts using a calculator (not illustrated) and a renderer (not illustrated). The calculator (not illustrated) calculates feature values such as coordinate values, shapes, sizes, and colors in which objects are respectively marked according to layouts of the screens based on the received controlling commands. The renderer (not illustrated) generates screens in various layouts including objects based on the calculated feature values from the calculator (not illustrated). The screens generated in the renderer (not illustrated) may be displayed within display areas of the display 110.

The above described operation of the controller 140 may be performed by the programs stored in the storage 150.

The storage 150 stores various data such as the O/S software module to drive the user terminal apparatus 100′ and various multimedia contents.

In particular, the storage 150 may store data including various UI screens provided from the display 110 according to an embodiment.

Further, the storage 150 may store data to generate controlling signals corresponding to user commands inputted through various UI screens.

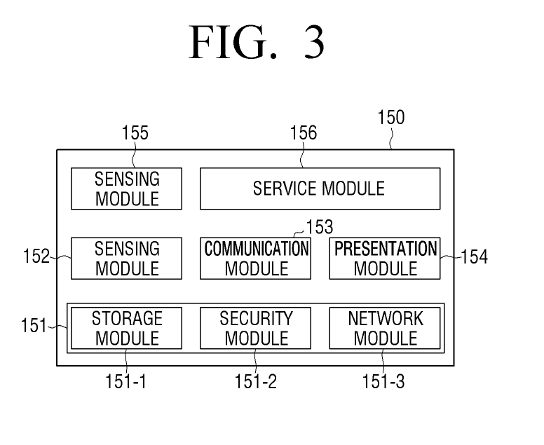

Further, various software modules stored in the storage 150 will be explained below by referring to FIG. 3.

Referring to FIG. 3, the storage 150 may store software including a base module 151, a sensing module 152, a communication module 153, a presentation module 154, a web browser module 155, and a service module 156.

The base module 151 indicates a basic module which processes signals delivered from each of hardware included in the user terminal apparatus 100′ and transmits them to upper layer modules. The base module 151 includes storage module 151-1, security module 151-2 and network module 151-3. The storage module 151-1 is a program module which manages a database (DB) or registry. The main CPU 143 may access the DB within the storage 150 using the storage module 151-1 and read various data. The security module 151-2 is a program module which supports certification, permission, and secure storage regarding hardware, and the network module 151-3 is a module which supports network connecting, and includes network protocols (e.g., DNET) module and a universal plug and play (UPnP) module.

The sensing module 152 is module which collects information from various sensors, analyzes and manages the collected information. The sensing module 152 may include touch recognizing module, head direction recognizing module, face recognizing module, voice recognizing module, motion recognizing module, and NFC recognizing module.

The communication module 153 is module which performs external communication. The communication module 153 may include a device module used in communicating with an external apparatuses, a messaging module such as a messenger program, short message service (SMS) & multimedia message service (MMS) program, e-mail program, and a call module including call info aggregator program module and VoIP module.

The presentation module 154 is a module including display screens. The presentation module 154 includes a multimedia module to play and output multimedia contents, and a UI rendering module to perform the processing UI and graphics. The multimedia module may include a player module, a camcorder module and a sound processing module. Therefore, the multimedia module reproduces various multimedia contents, reproduces screens and sounds, and plays them. UI rendering module may include an image compositor module to combine images, a coordinate combining module to combine and generate coordinates on the screen which will display images, an X11 module to receive various events from hardware, and a 2D/3D UI toolkit to provide tools for constituting the UI in 2D or 3D format.

The web browser module 155 indicates module which accesses the web server by performing the web browsing. The web browser module 155 may include various modules such as web view module to constitute web pages, download agent module to perform the downloading, bookmark module, and webkit module.

The service module 156 is module including various applications to provide various services. In particular, the service module 156 may include various program modules such as a SNS program, contents playing program, game program, electronic book program, calendar program, alarm managing program, and other widgets.

Although FIG. 3 illustrates various program modules, the described program modules may be partly deleted, modified, and added according to types and features of the user terminal apparatus 100′. For example, the user terminal apparatus 100′ may further include a position base module which supports a position based on a service by interoperating with a GPS chip.

The sensor 160 includes a touch sensor, a geomagnetic sensor, a gyro sensor, an acceleration sensor, a near field sensor, and a grip sensor. The sensor 160 may sense various manipulations such as rotating, tilting, pushing, approaching, and gripping, in addition to touching (described above).

The touch sensor may be implemented to be capacitive or decompressive. The capacitive touch sensor indicates a touch sensor according to the method in which dielectric materials coated on the surface of the display are used, and touch coordinate values are calculated by sensing micro-electricity excited by the user body when a part of a user body touches the display surface. The decompressive touch sensor indicates a touch sensor according to a method in which two electrode plates are included within the user terminal apparatus 100, and touch coordinate values are calculated by sensing the electrical flows when the upper and lower plates are contacted on the touched point in response to a user touching. Further, the infrared sensing method, the surface ultrasonic conductive method, the integral tension measuring method, and the piezo effect method may be used to sense touch interaction.

Further, the user terminal apparatus 100′ may determine whether a touch object, such as a finger or a stylus pen contacts or approaches using a magnetic sensor, an optical sensor, or an approaching sensor instead of the touch sensor.

The geomagnetic sensor is a sensor to sense a rotating status and moving a direction of the user terminal apparatus 100′. The gyro sensor is a sensor to sense a rotating angle of the user terminal apparatus 100′. Both of the geomagnetic sensor and the gyro sensor may be included. However, the user terminal apparatus 100′ may sense a rotating status even when any one of the geomagnetic sensor and the gyro sensor is included.

The acceleration sensor is a sensor to sense a tilting degree of the user terminal apparatus 100′.

The near field sensor is a sensor to sense an approaching motion without directly contacting the display surface. The near field sensor may be implemented with a high frequency oscillating type to form a high frequency magnetic field and sense electrical flows induced by the features of the magnetic field which change when an object approaches, a magnetic type to use the magnet, and a capacitive type to sense capacitive amount changed by approaching of an object.

The grip sensor is a sensor to sense a gripping of a user being provided on the back face, the boundary, and the gripping part, separately from the touch sensor included on the touch screen of the user terminal apparatus 100. The grip sensor may be implemented to be a pressure sensor instead of the touch sensor.

The user terminal apparatus 100′ may further include an audio processor (not illustrated) to perform the processing regarding audio data, a video processor (not illustrated) to perform the processing regarding video data, a speaker (not illustrated) to output various alarm sounds or voice messages as well as various audio data processed in the audio processor (not illustrated), and a microphone (not illustrated) to receive the inputted user voices or other sounds and convert them into audio data.

FIG. 2B illustrates one example of the detailed constitution included in the user terminal apparatus 100′. According to an exemplary embodiment, the devices illustrated in FIG. 2B may be partly deleted or modified, or other new devices may be further added. For example, it may further include a Digital Multimedia Broadcasting (DMB) receiver (not illustrated) to receive and process DMB signals.

FIG. 2C is a block diagram of the electronic apparatus according to an exemplary embodiment.

As illustrated in FIG. 1B, the electronic apparatus 200 may be implemented to be a digital TV. However, it may not be limited to the above. The electronic apparatus 200 may be implemented to be a device that can be provided with the display function and remote-controlled such as a PC, navigation, kiosk, and Digital Information Display (DID).

The communicator 210 may perform communication with the user terminal apparatus 100. In particular, the communicator 210 may perform communication with the user terminal apparatus 100 through various communication methods.

In particular, the communicator 210 may receive signals corresponding to various user interactions input through the user interface 120 from the user terminal apparatus 100.

The communicator 210 may transmit signals corresponding to a status of the electronic apparatus 200, and signals corresponding to functions performed in the electronic apparatus 200 to the user terminal apparatus 100.

The display 220 may provide various display screens that can be provided through the electronic apparatus 200.

In particular, the display 220 may display various UI screens that can be manipulated through the user terminal apparatus 100. For example, the display 220 may displays various formats of UI screens such as a channel zapping screen (e.g., channel searching screen), a volume adjusting screen, various menu screens, and a web page screen.

The controller 230 performs a function to control a general operation of the electronic apparatus 200.

The controller 230 may control an operating status of the electronic apparatus 200, e.g., a display status according to the received signals from the user terminal apparatus 100. As described above, the received signals from the user terminal apparatus 100 may be signals corresponding to a user interaction status or a controlling signal to control the electronic apparatus 200 which are converted from the signals corresponding to user interaction situation. When the received signals from the user terminal apparatus 100 are signals corresponding to user interaction situation, the controller 230 may convert corresponding signal to controlling signals in order to control the electronic apparatus 200.

In particular, the controller 230 may control the display status regarding various formats of UI screens such as the channel zapping screen, the volume the adjusting screen, various menu screens, and the web page screen according to the received signals from the user terminal apparatus 100. Specific display statuses will be described below by referring to the drawings.

The following will explain various exemplary embodiments by referring to drawings. For convenience, it is assumed that the physical guide may be a cross-shape protrusion.

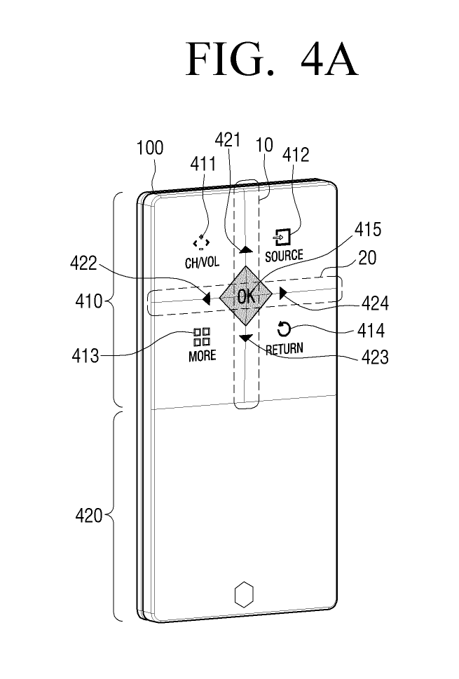

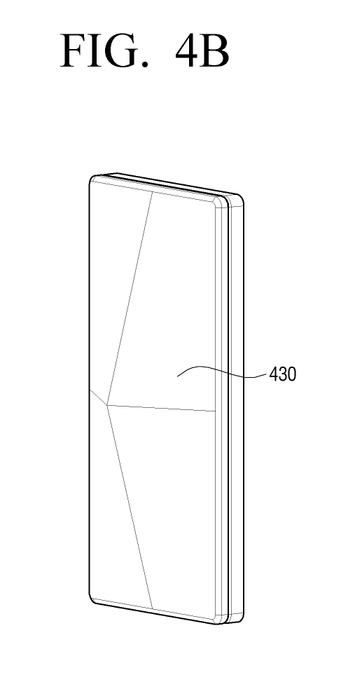

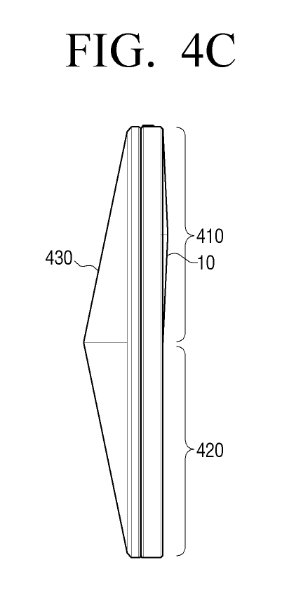

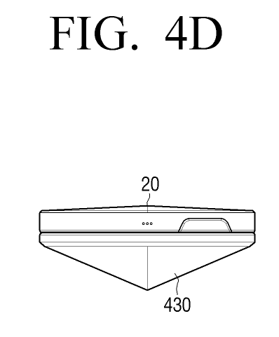

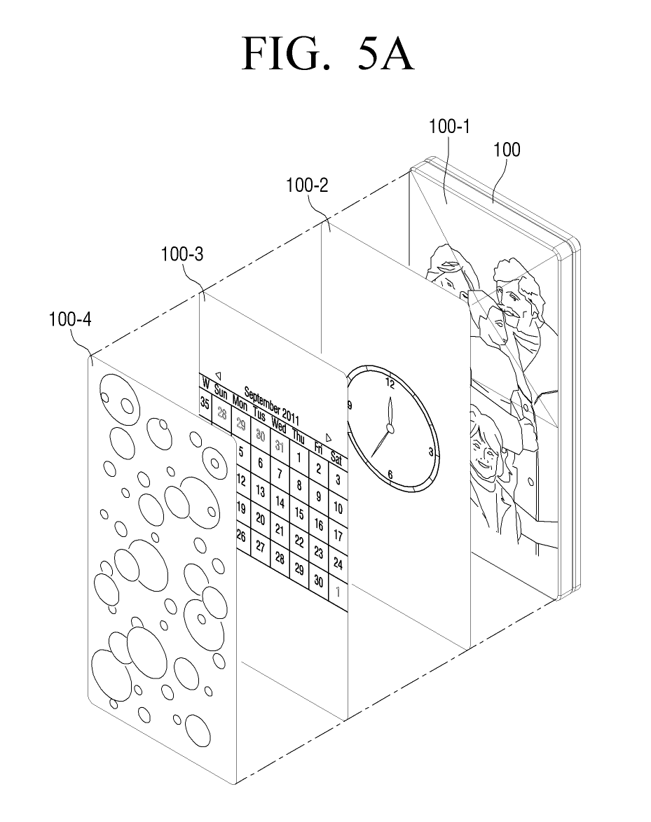

FIGS. 4A to 4D are views provided to explain a structure of the user terminal apparatus according to an embodiment.

FIG. 4A illustrates a front view of the user terminal apparatus 100. As described above, the front part of the user terminal apparatus 100 may be divided into a first area 410 including the protrusion 10, 20, and a second area 420 excluding the protrusion 10, 20. The first area 410 and the second area 420 may be provided to include the touch screen, and a corresponding UI of a context in the external electronic apparatus 200 may be provided on the touch screen.

The first area 410 may be formed on the upper face of the user terminal apparatus 100, and includes first to fourth sub areas 411 to 414 divided based on the upper-lower-left-right direction protrusion 10, 20. Further, the first area 410 may include a fifth sub area 415 formed on the center area of the protrusion 10, 20.

Various menu items may be provided on the first to the fifth sub areas 411 to 415, and menu items provided on corresponding area may be modified according to a UI type provided on the first area 410. A menu item may be displayed based on the stored information in the user terminal apparatus 100, or based on the received information from the external electronic apparatus 200 that can be controlled or an external server (not illustrated).

For example, according to an embodiment, the first to the fifth sub areas 411 to 415 may provide channel/volume menu, source menu, add menu, return menu, and confirm menu. According to another embodiment, the first to the fifth sub areas 411 to 415 may provide a menu regarding various categories provided from the electronic apparatus 200. For example, menu indicating real-time TV view category, VOD contents base category, SNS contents share base category, application provide category, and personal contents category, and select menu button may be respectively provided on each of the first to the fifth sub areas 411 to 415. However, this is merely one of embodiments, and various menu items may be provided according to UI types in the first to the fifth sub areas 411 to 415.

Various menu items provided from the first to the fifth sub areas 411 to 415 may be shortcut menu items in which a corresponding menu is immediately implemented while the electronic apparatus 200 is turned on according to the menu select item.

The protrusion 10, 20 may be formed to be a cross-shape on the first area 410 in a lower titling format from the center to the surrounded directions. In particular, the protrusion 10, 20 may be a format in which the first protrusion 10 are formed toward the upper-and-lower direction and the second protrusion 20 are formed toward the left-and-right direction and crossed with each other on the center. Further, four directional buttons 421 to 424 may be formed on the upper, lower, left, and right directions of the protrusion 10, 20.

The UI screen in FIG. 4A describes an exemplary embodiment. However, the UI screen may be variously modified according to a status of the external electronic apparatus 200 or user commands regarding the user terminal apparatus 100. Further, the protrusion may be provided in various formats.

The structure of the protrusion 10, 20 may provide various manipulations with tactile feelings without checking the user terminal apparatus 100 by a user. For example, the first protrusion 10 formed toward the upper-and-lower direction shows lower tilting format toward the upper and the lower sides based on the center. Thus, a user may recognize the lower tilting area toward the upper direction with tactile feelings while an upper directional manipulation such as volume-up is performed. Further, a user may recognize the lower tilting area with tactile feeling toward the lower direction while a lower directional manipulation such as volume-down is performed. Other various user interactions through the protrusion 10, 20 will be described below by referring to drawings.

FIG. 4B illustrates a rear view of the user terminal apparatus 100. The lower side of the user terminal apparatus 100 may include the support 430 in the protruded pyramid format.

The support 430 may be provided to stand up the user terminal apparatus 100 on a supportable object such as table. Thus, a user may stand the user terminal apparatus 100 toward one direction, among four directions, which is supported through the support 430 in the protruded pyramid format on a table.

FIG. 4C illustrates a side view of the user terminal apparatus 100. In a view from the side section, the first protrusion 10 has a lower tilting format on the first area 410 toward both directions from the center in the cross-shape. Further, the left-and-right side of the support 430 is protruded on the lower side.

FIG. 4D illustrates a planar view of the user terminal apparatus 100. In a view from the upper section of the user terminal apparatus 100, the second protrusion 20 has a lower tilting format on the second area 420 toward both directions from the center in the cross-shape. Further, the upper-and-lower side of the support 430 is protruded on the lower side.

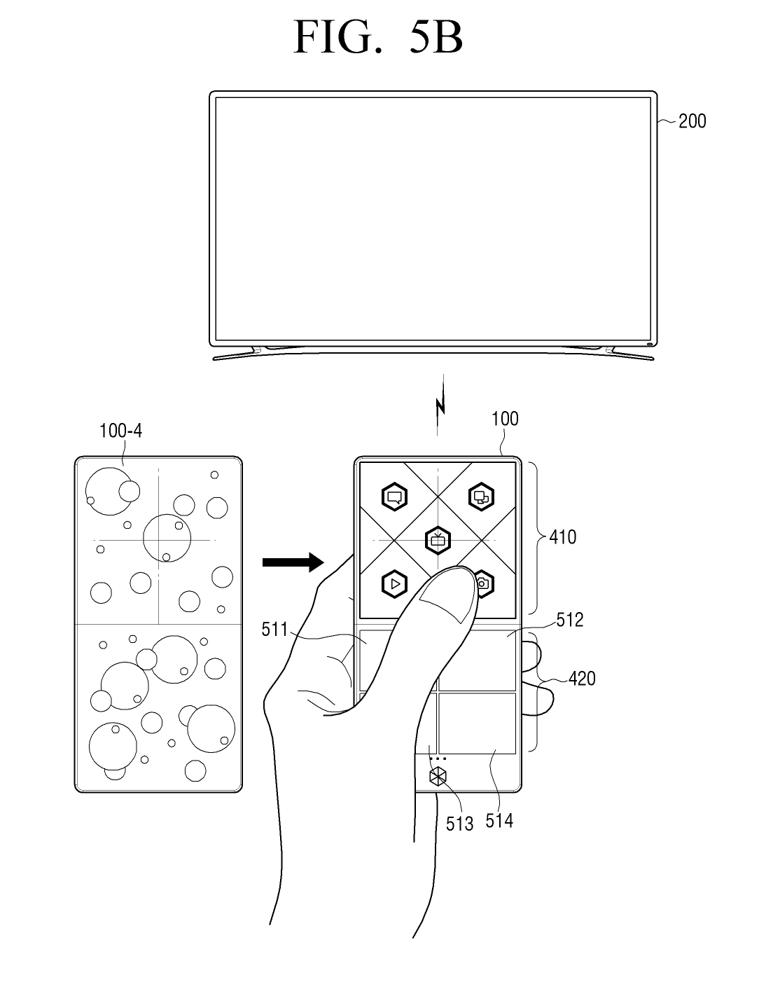

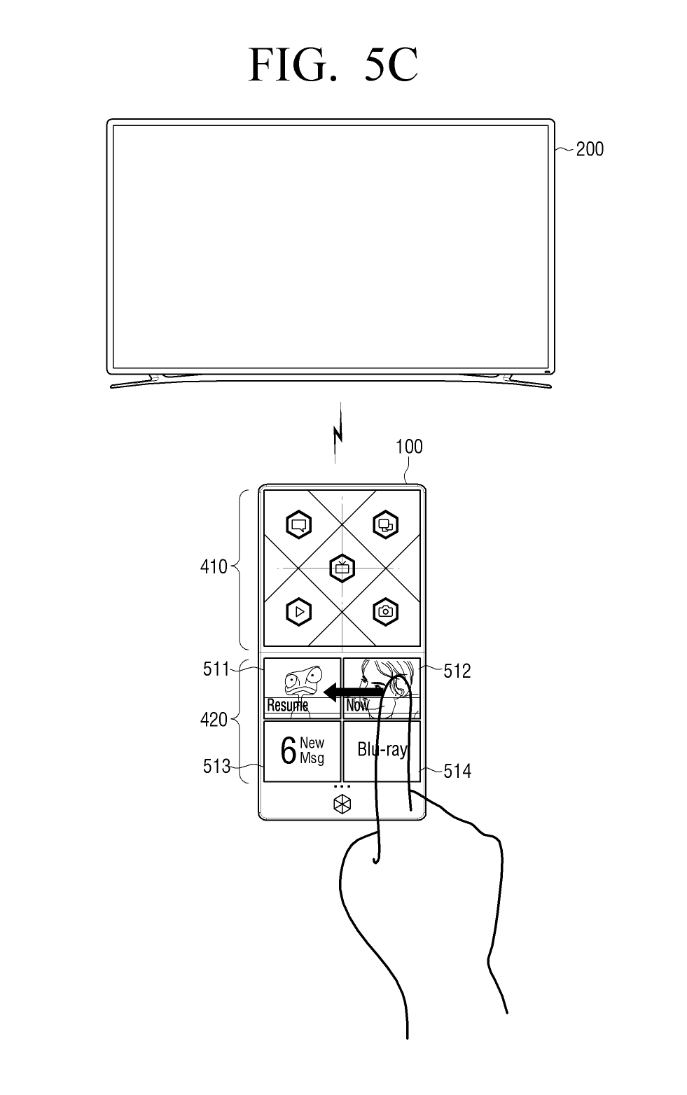

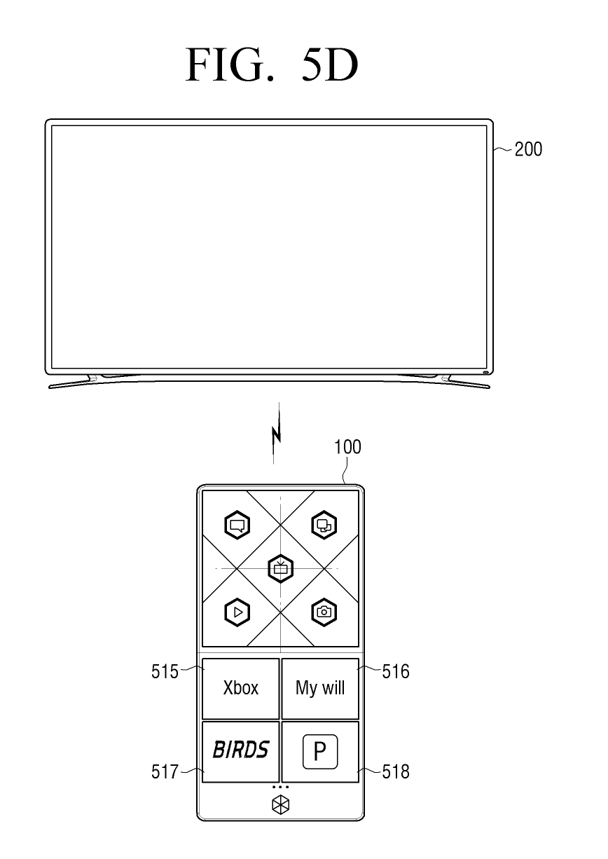

FIGS. 5A to 5D are views provided to explain operation of the user terminal apparatus according to an embodiment.

As illustrated in FIG. 5A, the user terminal apparatus 100 operates in the wallpaper mode to display contents such as widgets, idle applications, pictures and animation in the stand-by mode.

In particular, as illustrated, widgets such as a clock 100-2 and a calendar 100-3, and contents including customized pictures 100-1 and images 100-4 may be provided in the wallpaper mode of the user terminal apparatus 100.

As illustrated in FIG. 5B, when a preset event such as a user grapping manipulation occurs, the user terminal apparatus 100 may display an initial screen.

The initial screen may include menu items displayed on the first area 410 where the protrusion is provided, and various information displayed on the second area 420 where the protrusion is not provided, as illustrated in FIG. 5C. Menu items displayed on the first area 410 have been previously described in FIG. 4A, so further explanation will be omitted.

The second area 420 may provide items such as a previous view menu 511 to continue to view previous contents, current broadcasting menu 512 to view currently airing contents, a message menu 513 to provide new messages, and an input source menu 514 to provide input sources that can be connected. The menu displayed on the second area 420 may be a shortcut menu in which a corresponding menu is performed while the electronic apparatus 200 is turned on according to a selection of the corresponding menu.

When touch and flick manipulation is input, the second area 420 may provide the menu items as illustrated in FIG. 5D. For example, it may provide items 515 to 518 indicating various applications in FIG. 5D on a next page.

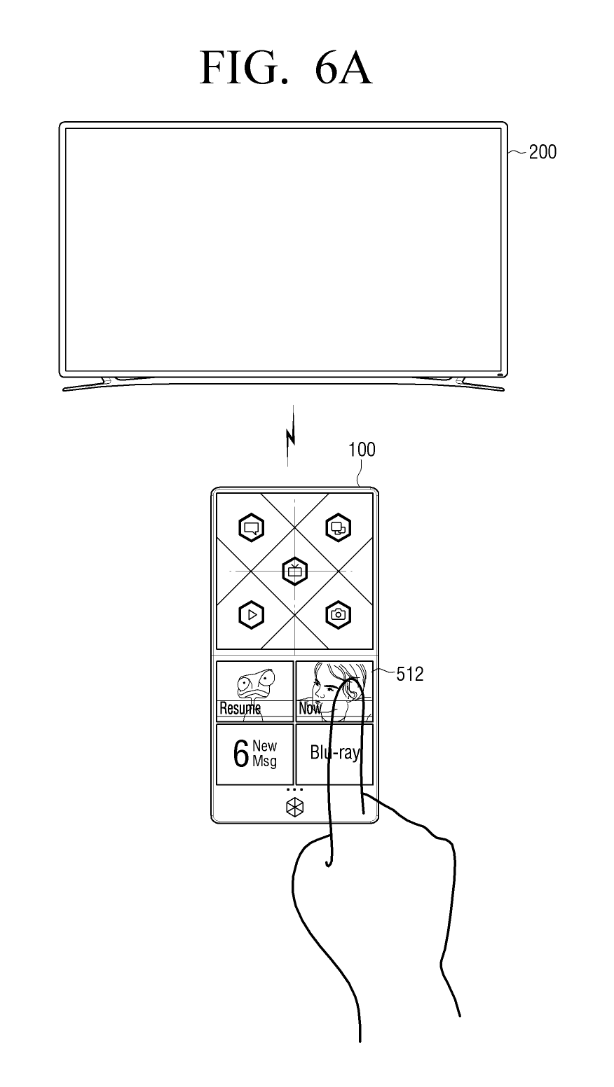

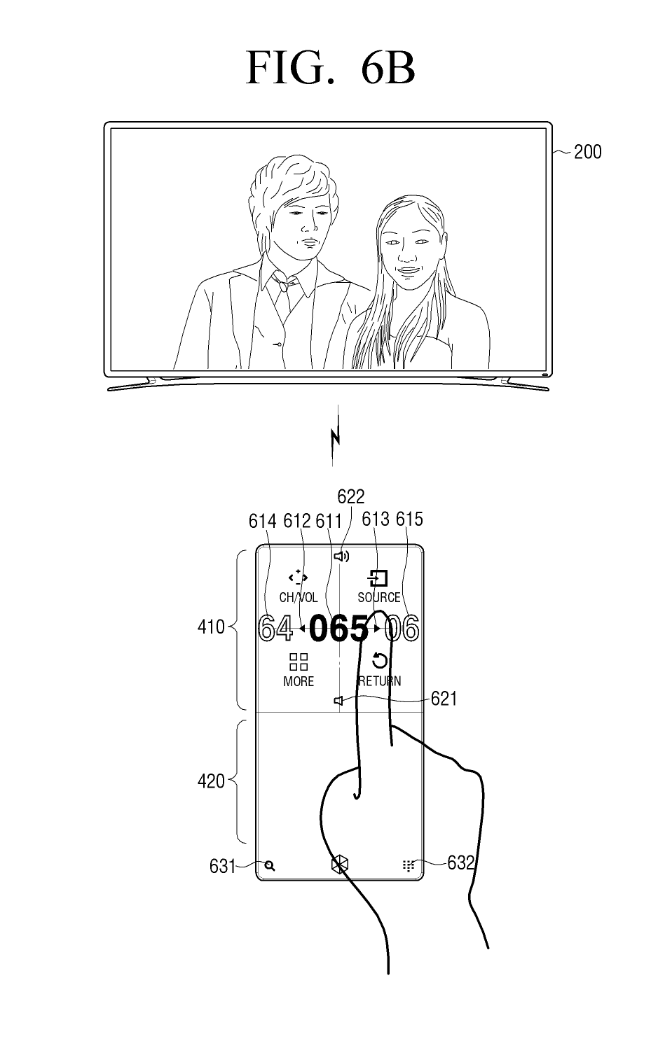

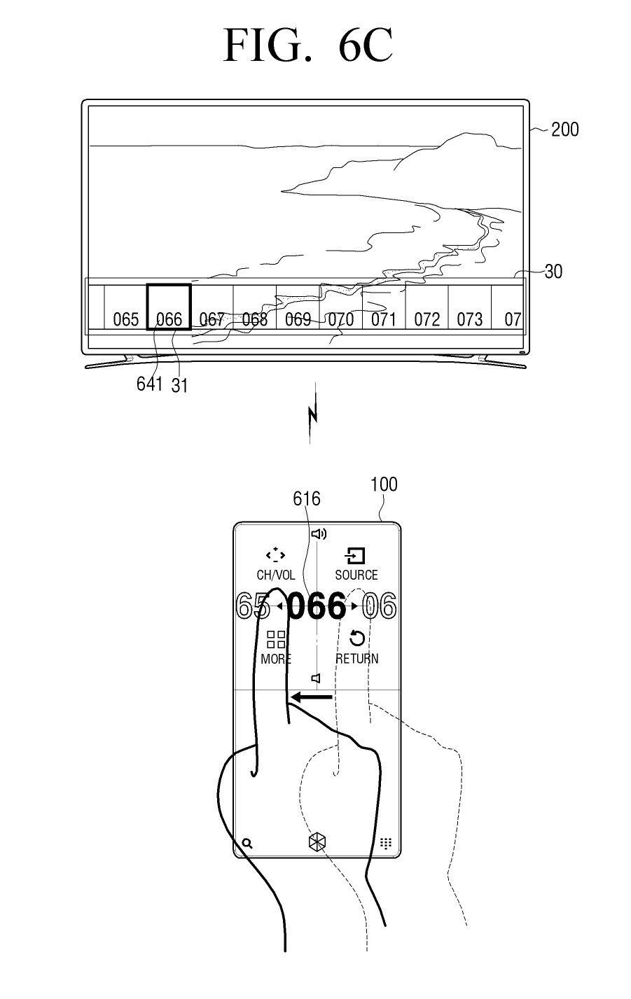

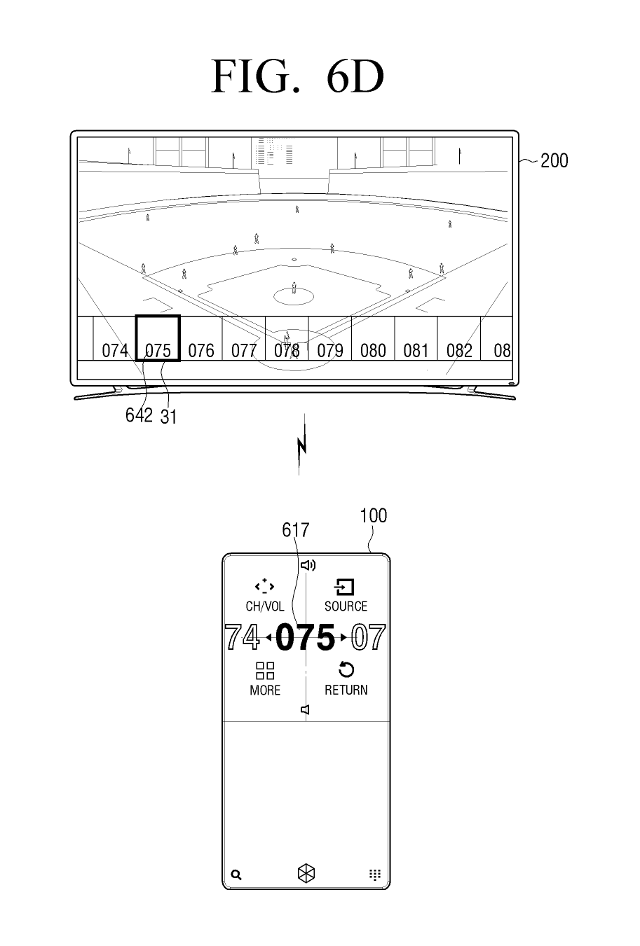

FIGS. 6A to 6D are views provided to explain an operation of the user terminal apparatus according to another embodiment.

As illustrated in FIG. 6A, when the current broadcasting menu item 512 is selected among the items 511 to 514 illustrated in FIG. 5C, corresponding selecting signals may be transmitted to the electronic apparatus 200, and a currently airing channel may be selected and displayed while the electronic apparatus 200 is turned on. In this case, a currently airing channel may be one of the most recently selected channels by a user preset channel regarding corresponding menu by a user, and a user favorite channel.

In this case, the first area 410 of the user terminal apparatus 100 may provide a UI for zapping channels (e.g., channel searching) as illustrated in FIG. 6D. For example, the user terminal apparatus 100 may provide a current channel number 611 and direction GUI 612, 613 to zap previous channels and next channels on the second protrusion 20 area. Previous and next channel numbers 614, 615 may be partly displayed, and corresponding channel numbers may be displayed and distinguished from the current channel number 611. For example, the current channel number 611 may be displayed with a highlight, and the previous channel numbers and next channel numbers 614, 615 may be displayed without a highlight.

Further, UI 621, 622 which adjusts the volume may be provided on the first protrusion 10 area. UI 621, 622 which adjusts the volume may be a format in which a GUI 621 indicating mute status and a GUI 622 indicating maximum volume status are respectively displayed on the most lower and the most upper of the first protrusion 10.

When the UI to control specific mode of the electronic apparatus 200 is provided on the first area 410, displayed information on the second area 420 may close such that the second area 420 may not display any information. However, exemplary embodiments may not be limited to the above.

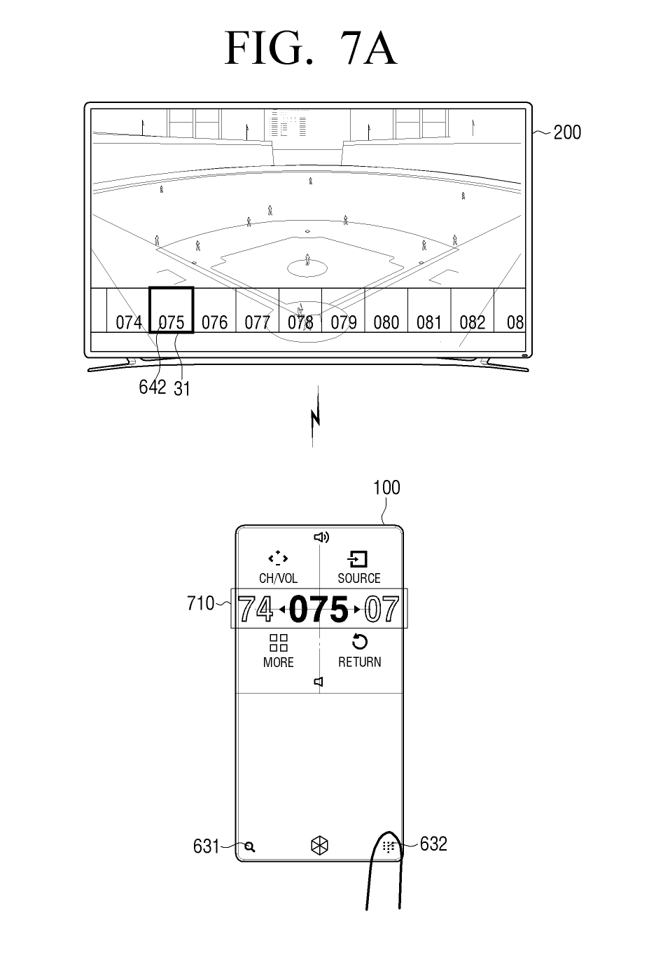

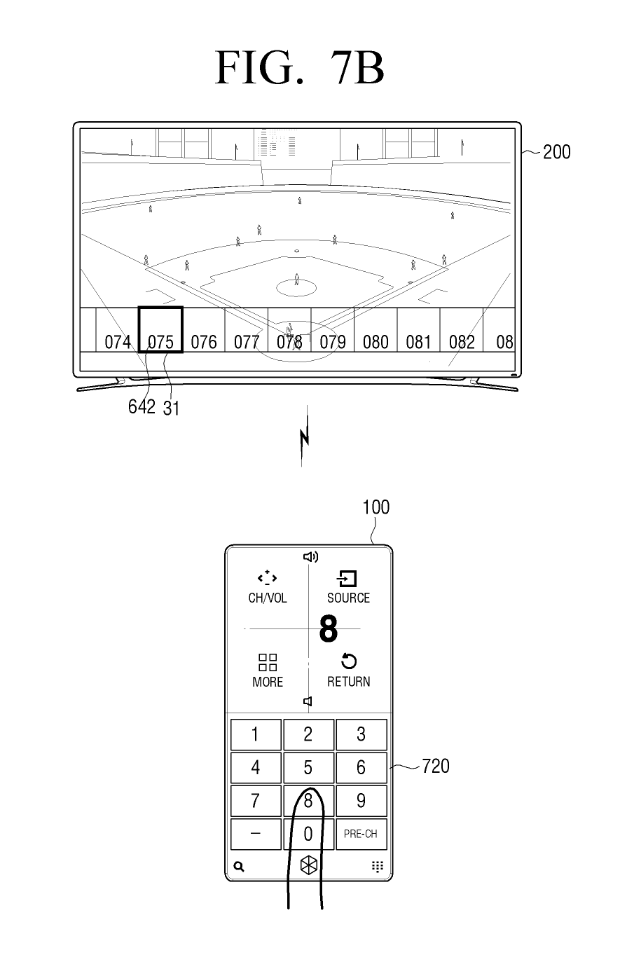

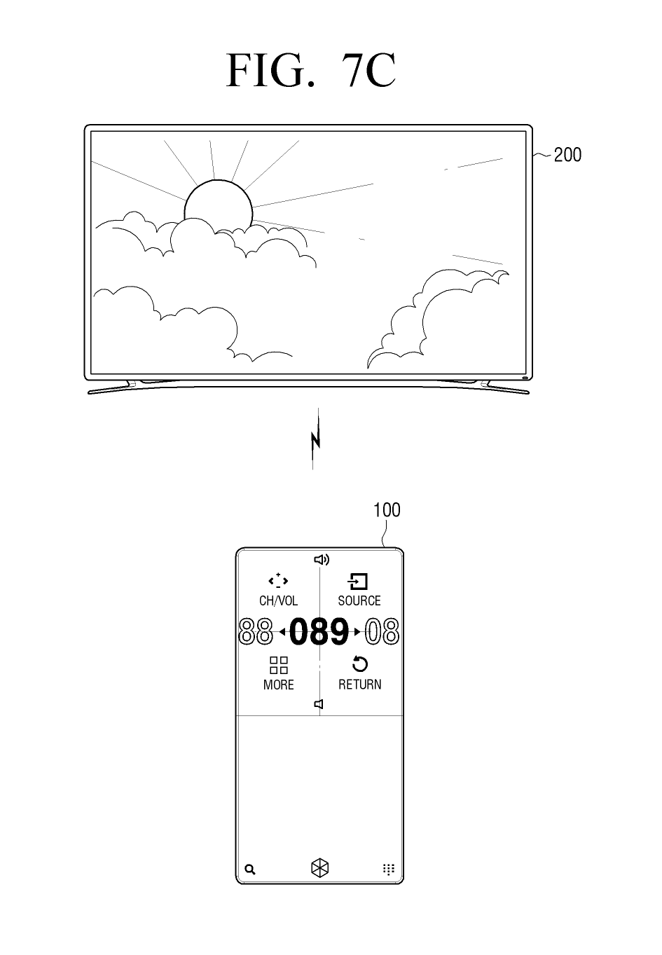

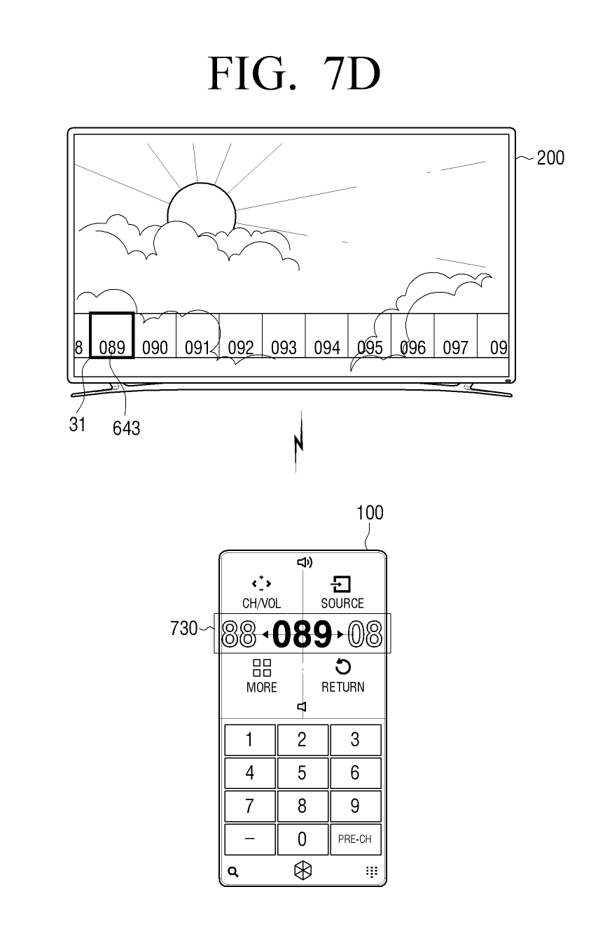

As illustrated in FIG. 6B, the second area 420 may provide a menu item 631 for searching and menu item 632 for providing a UI for inputting characters. The menu item 631 for searching is a menu item to perform the searching in the user terminal apparatus 100 or the electronic apparatus 200. When a corresponding menu item 631 is selected, a searching window and a UI for inputting characters may be provided on the user terminal apparatus 100, or a searching window may be provided on the electronic apparatus 200 while a UI for inputting characters may be provided on the user terminal apparatus 100. The menu item 632 for providing a UI for inputting characters will be described below by referring to FIG. 7A.

When selecting the direction GUI 613 to zap toward the next channel as illustrated in FIG. 6B, the current channel number 611 provided on the second protrusion 20 area may be modified into the selected next channel number 616 according to selecting the direction GUI 613, and displayed.

Further, on the electronic apparatus 200, broadcasting contents of the selected next channel may be provided according to selecting the direction GUI 613 while a channel list 30 may be provided on the lower side of the screen. In this case, the channel list 30 may be provided in a format in which GUIs are in a block shape including information regarding channels that can be provided and are consecutively arranged on the lower side of the display screen. However, the exemplary embodiments may not be limited to the above.

The block GUI 641 indicating a currently selected channel on the channel list 30 may display the select GUI 31 such as a cursor or a highlight so that the currently selected channel can be displayed and distinguished from the other channels.

Further, as illustrated in FIG. 6C, when a user interaction to scroll or drag (scroll is hereinafter used as an example) from the left direction to the right direction of the second protrusion 20 is input, the electronic apparatus 200 may perform zapping channels corresponding to scroll velocity. In this case, a plurality of block GUIs including channel information provided on the screen of the electronic apparatus 200 may move toward a direction corresponding to the user interaction on the user terminal apparatus 100. Further, when a user dragging manipulation is finished or lifted off, movement of GUIs are stopped as they are displayed.

For example, as illustrated in FIG. 6C, when a user interaction to quickly scroll from the left direction to the right direction of the second protrusion 20 in the user terminal apparatus 100 is input while channel 66 is being selected, channel zapping may be performed so as to correspond to scroll velocity and Channel #75 which corresponds to the time point when the scroll stops may be selected as illustrated in FIG. 6D. In this case, the block GUIs including channel information moves so as to correspond to the scroll velocity on the UI provided on the second protrusion 20 area of the user terminal apparatus 100, and stops and displays at the time point when the scroll velocity stops.

FIGS. 7A to 7E are views provided to explain an operation of the user terminal apparatus according to another embodiment.

As illustrated in FIG. 7A, when the menu item 632 to provide the UI for inputting characters is selected while displaying the UI 710 for zapping channels, UI 720 for inputting characters may be provided on the lower area of the user terminal apparatus 100 as illustrated in FIG. 7B. In this case, UI 720 for inputting characters may be provided in the UI format for inputting numbers according to the status of the display apparatus 100. For example, when the electronic apparatus 200 is zapping channels as illustrated in FIG. 7B, the UI 720 for inputting numbers can be immediately provided.

As illustrated in FIGS. 7B and 7C, when number “8” and number “9” are consecutively selected, number “8” and number “9” may be consecutively input and displayed on the area where the UI for zapping channels was displayed.

As illustrated in FIG. 7D, the user terminal apparatus 100 may display the UI 730 for zapping channels again, and the electronic apparatus 200 may select and display Channel #89. In this case, the cursor 31 may be moved and marked on the block GUI 643 indicating Channel #89 on the channel list 30 provided on the lower side of the screen in the electronic apparatus 200.

In response to a preset event occurring after Channel #89 is selected through the UI for inputting numbers as illustrated in FIG. 7D, the channel list 30 provided from the lower side of the screen in the electronic apparatus 200 may disappear from the screen. A preset event may be an event in which a preset time passes after selecting a channel, and an event in which a preset button (e.g., confirm button or exit button) is input after selecting a channel.

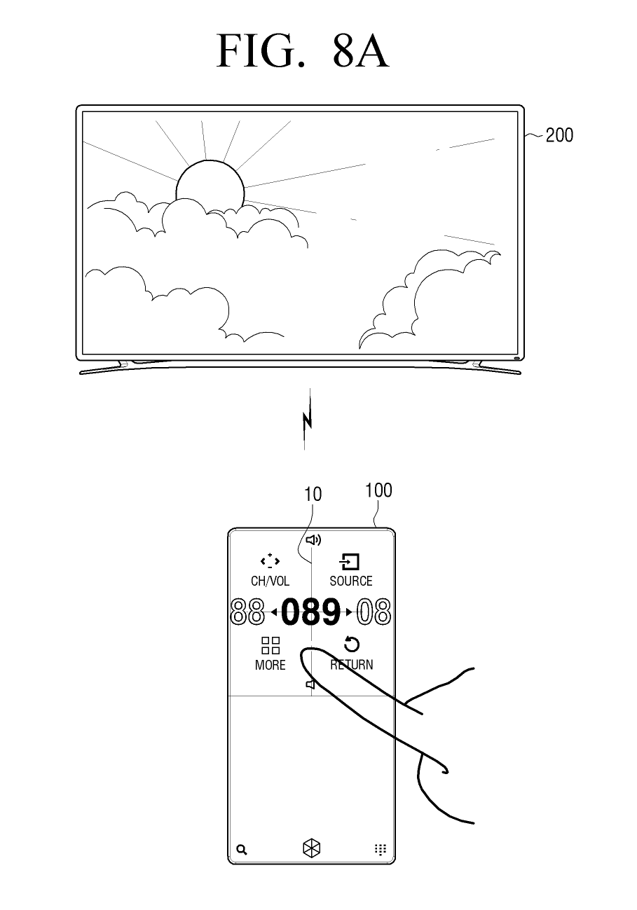

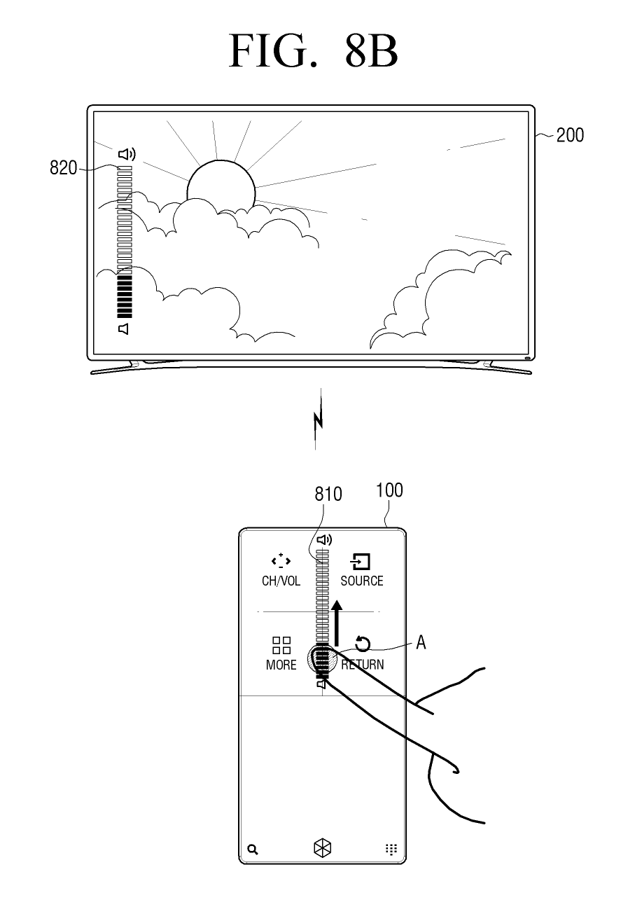

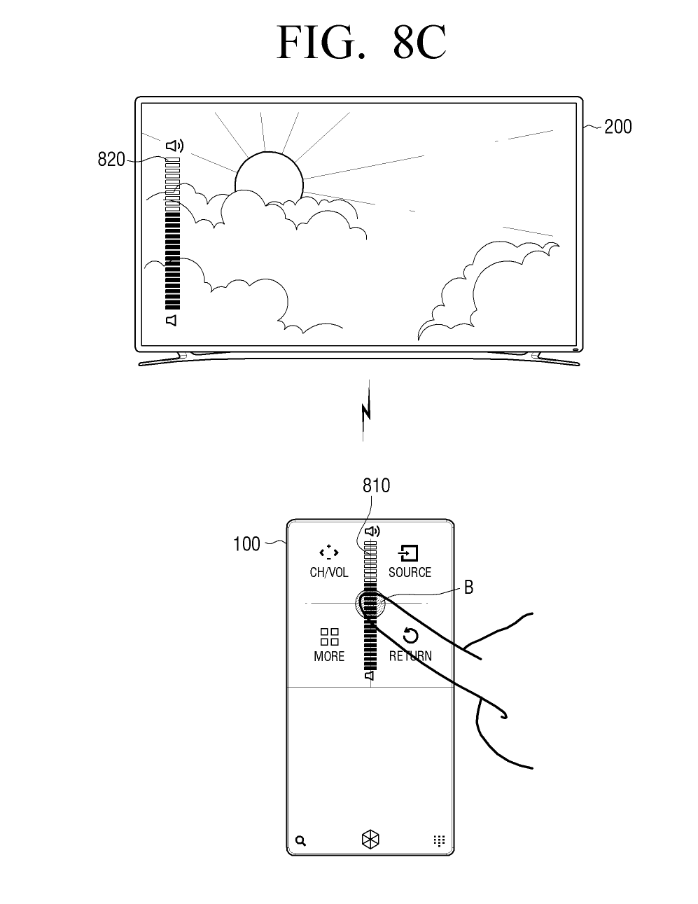

FIGS. 8A to 8C are views provided to explain operation of the user terminal apparatus according to another embodiment.

As illustrated in FIG. 8A, when touch interaction is performed on one area corresponding to the first protrusion 10 of the user terminal apparatus 100, functions controlled by the first protrusion 10, e.g., the volume adjusting function, may be activated by the user terminal apparatus 100.

As illustrated in FIG. 8B, the volume adjusting UI 810 may be provided on an area corresponding to the first protrusion 10. In this case, a uniform UI 820 may be displayed on one area of the screen in the electronic apparatus 200.

As illustrated in FIGS. 8B and 8C, when a user interaction to touch and scroll one area of the volume adjusting UI 810 is input, the volume of the electronic apparatus 200 may be adjusted according to a corresponding user interaction, and an animation GUI which dynamically reflects the corresponding scroll manipulation may be provided on the volume adjusting UIs 810, 820. For example, when the touch interaction is performed on A area of the volume adjusting UI 810 (see FIG. 8B), and scrolling or dragging is manipulated following to the first physical guide to B area (see FIG. 8C), the volume of the electronic apparatus 200 may be adjusted so as to correspond to the above scrolled manipulation, and an animation GUI which modifies a highlight according to the scrolling manipulation may be provided on the volume adjusting UIs 810, 820.

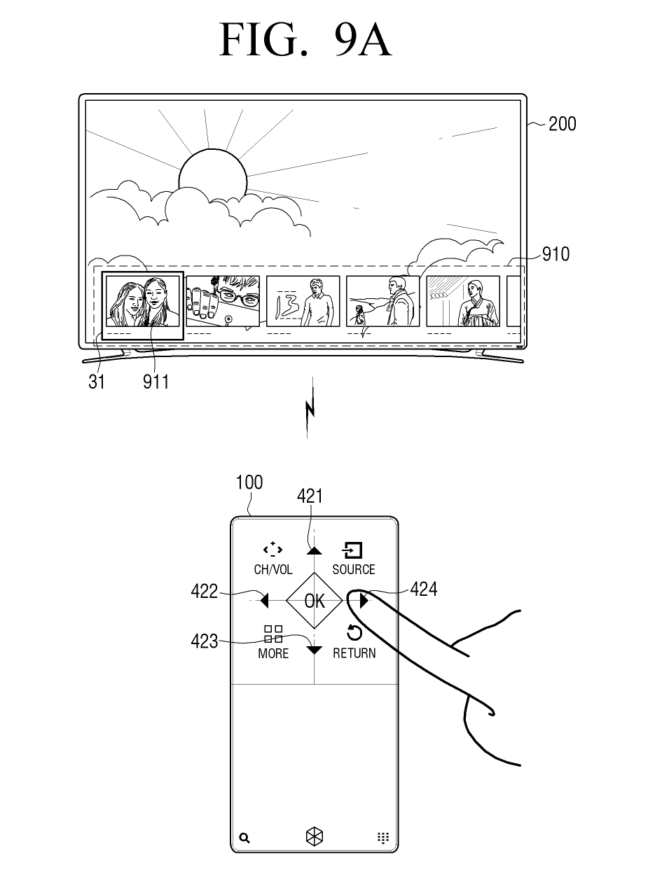

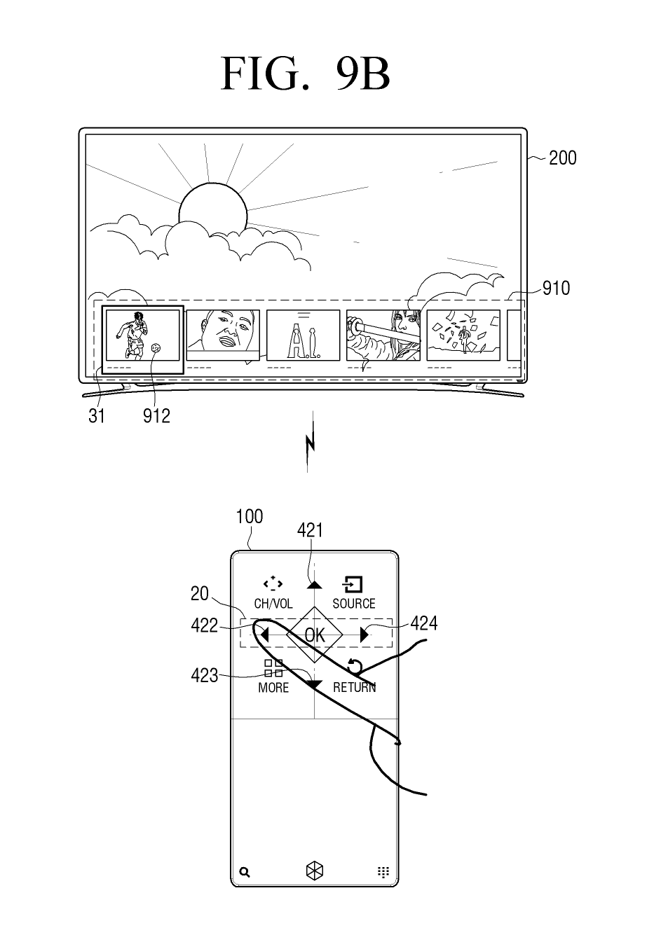

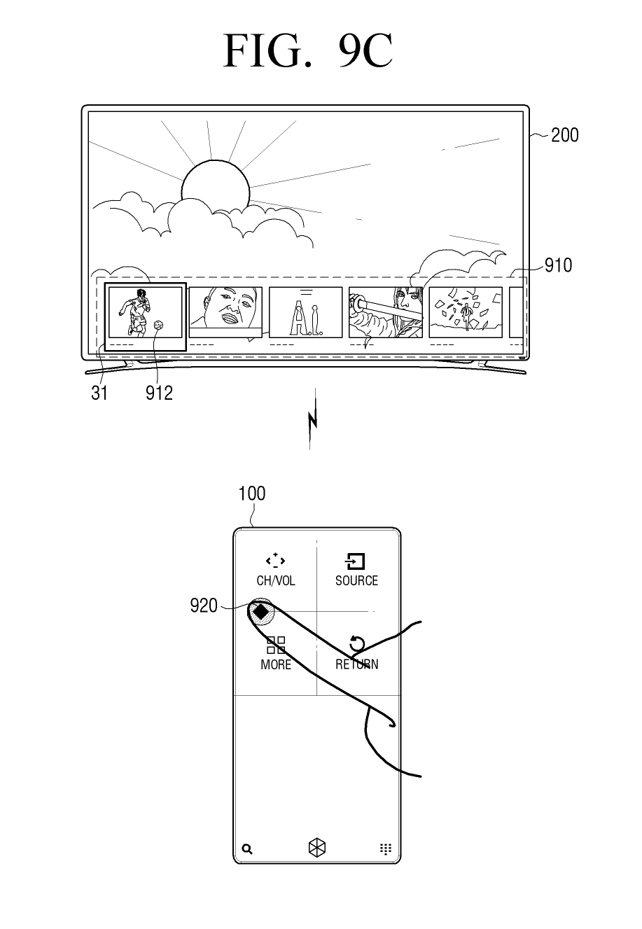

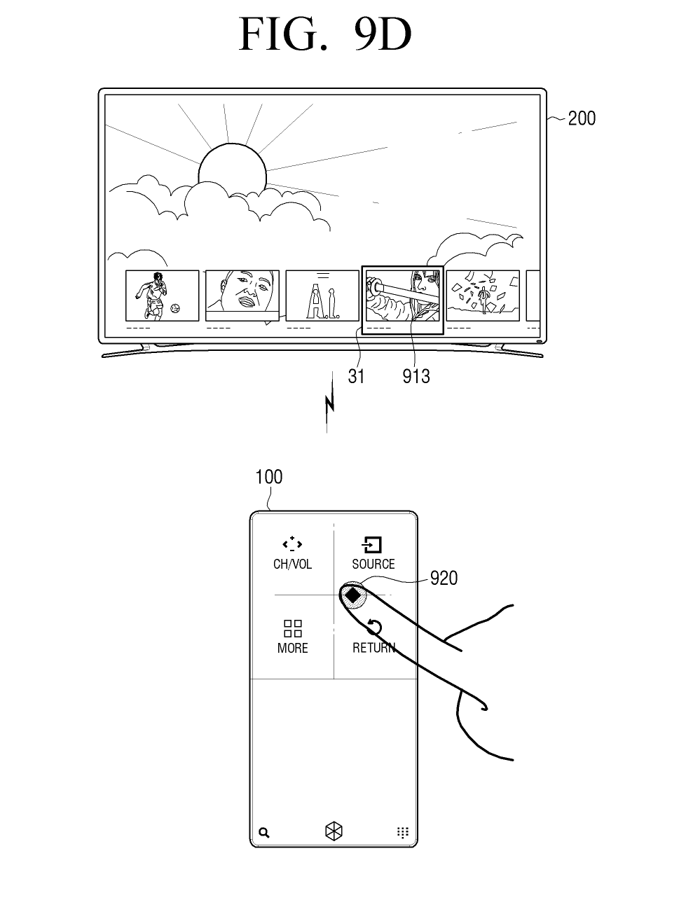

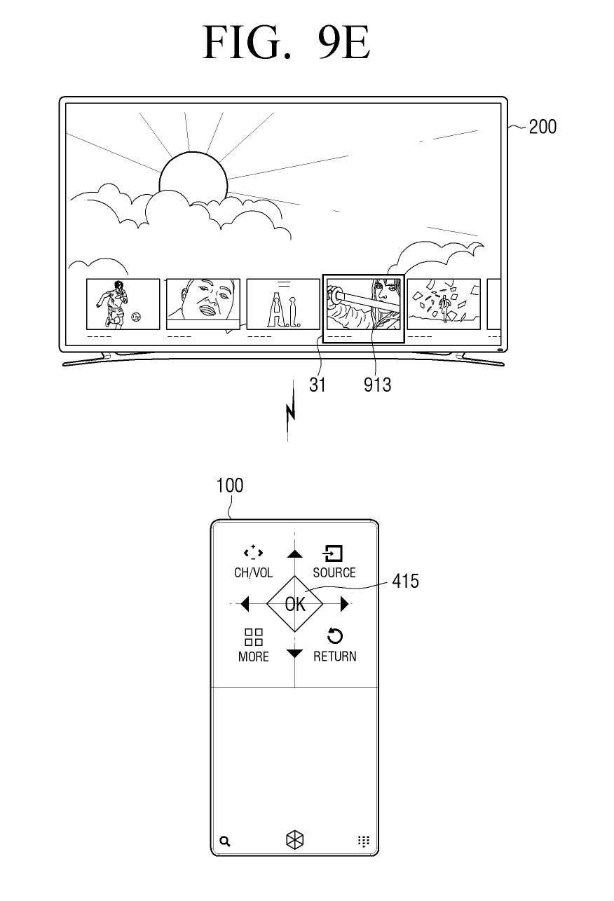

FIGS. 9A to 9E are views provided to explain operation of the user terminal apparatus according to another embodiment.

As illustrated in FIG. 9A, recommended contents list 910 may be provided on the lower of the screen in the electronic apparatus 200 according to a preset event. The recommended contents list 910 may be provided in a format in which the block GUIs which include contents information are consecutively arranged similar to the channel list 30. However, exemplary embodiments may not be limited to the above.

The recommended contents list 910 may be modified into a next page and provided according to a user interaction to push the direction buttons 421 to 424 provided on the user terminal apparatus 100. For example, as illustrated in FIG. 9A, according to the user interaction to push the left direction button 424, next contents list which is not previously provided may be provided on the screen as illustrated in FIG. 9B.

The select GUI 31 for selecting contents may be displayed on the recommended contents list 910. The select GUI 31 may be moved and displayed corresponding to contents to the user interaction of the user terminal apparatus 100. For example, when a next contents list, which is not previously provided, is displayed on the screen as illustrated in FIG. 9B according to the user interaction to push the left direction button 424 as illustrated in FIG. 9A, the select GUI 31 displayed on the first contents 911 in FIG. 9A may be moved and displayed on the first contents 912 of the next contents list.

The second protrusion 20 may be modified to receive the input scroll manipulation according to a preset user interaction regarding the second protrusion 20 of the user terminal apparatus 100, as illustrated in FIG. 9B. A preset user interaction may be a user interaction to push one area of the second protrusion 20 for more than a preset time. However, exemplary embodiments may not be limited to the above. In this case, a GUI displayed on the second protrusion 20 may be modified so as to correspond to the modified situation. For example, as illustrated in FIG. 9C, the four directional buttons and the select menu button (or confirm button) displayed on the first protrusion 10 and the second protrusion 20 may disappear, and a GUI 920 for tracking the scroll may be provided.

As illustrated in FIGS. 9C and 9D, when a user interaction to scroll the second protrusion 20 is input, the select GUI 31 provided on the recommended contents list 910 may move toward the corresponding direction to the user interaction and stop movement at the time point when the scroll manipulation is finished or lifted off. For example, the select GUI 31 placing on the first contents 912 of FIG. 9C may move and place on the fourth contents 913 according to the scroll manipulation as illustrated in FIG. 9D.

Although not illustrated in the drawings, when the scroll manipulation is performed continuously, the contents list moves toward one direction, i.e., displays next contents list and stops as it is displayed at the time point when the scroll manipulation is finished or lifted off.

Further, when the scroll manipulation is lifted off as illustrated in FIG. 9E, the select menu button of the fifth sub area 415 may be displayed again on the crossed point of the first protrusion 10 and the second protrusion 20.

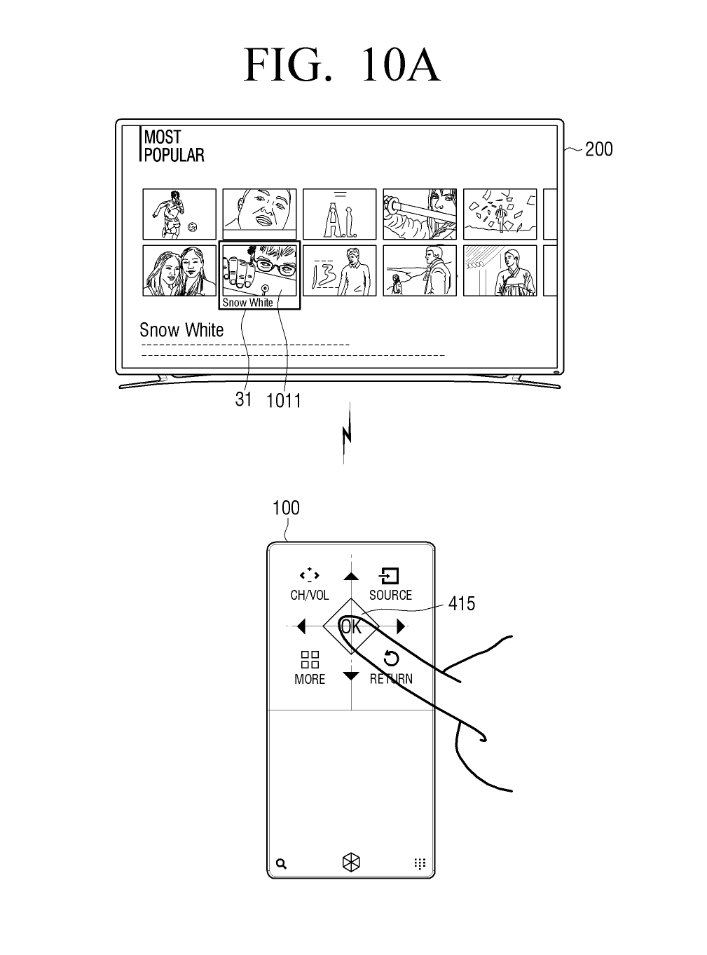

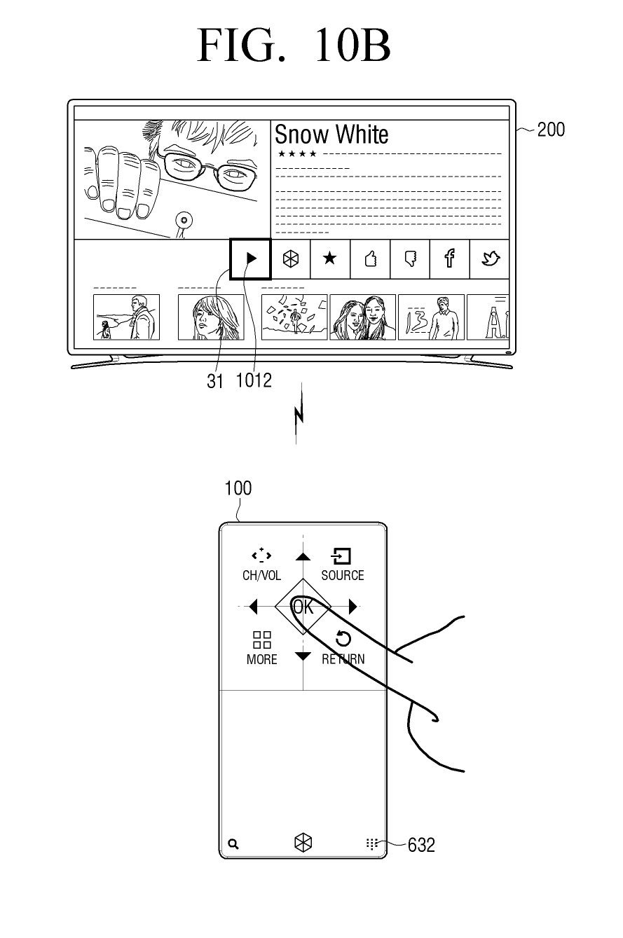

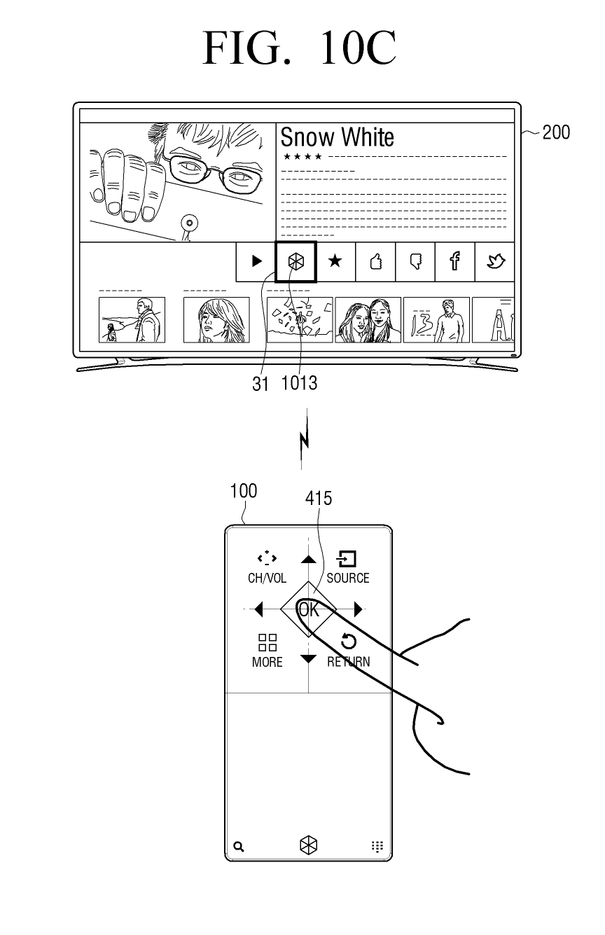

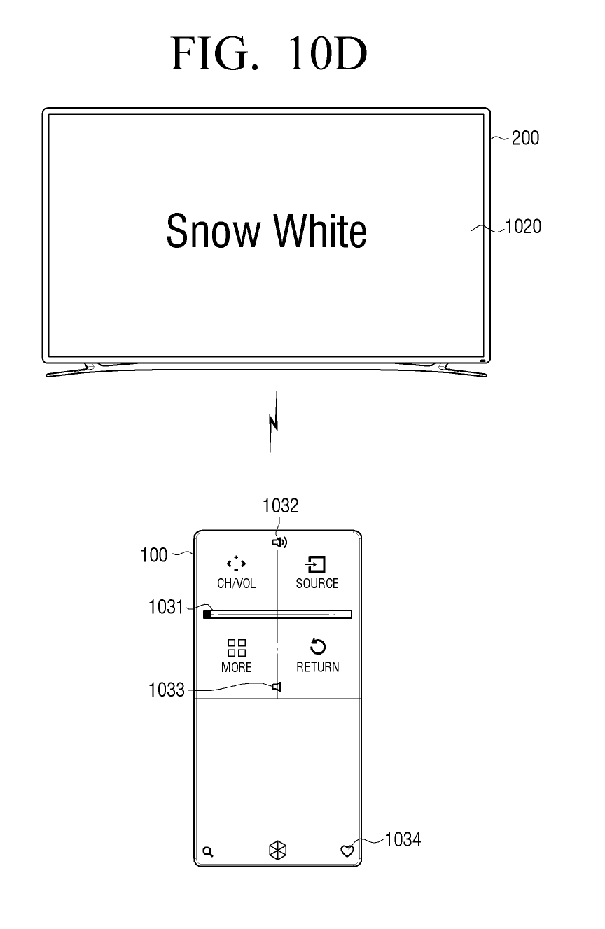

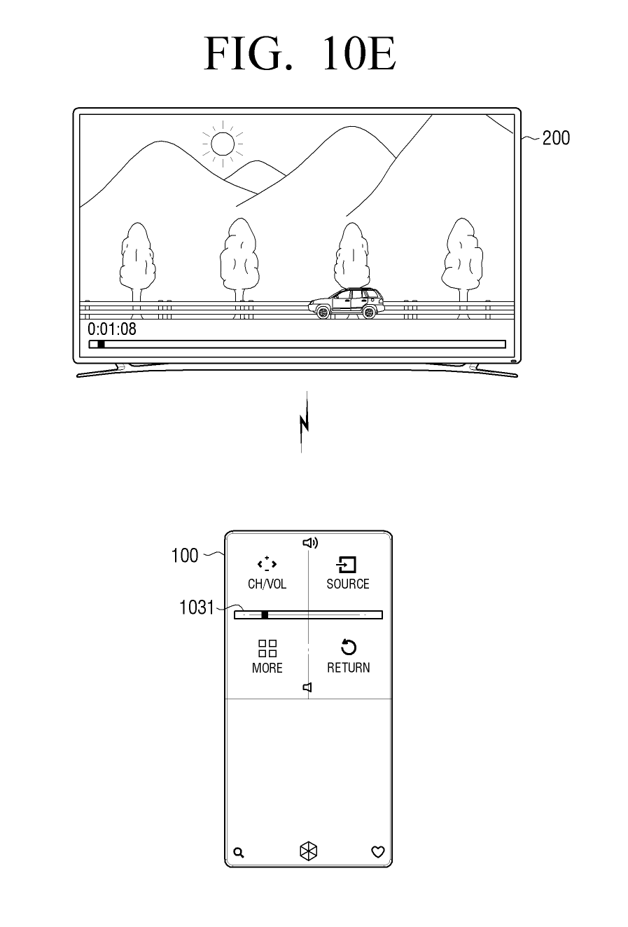

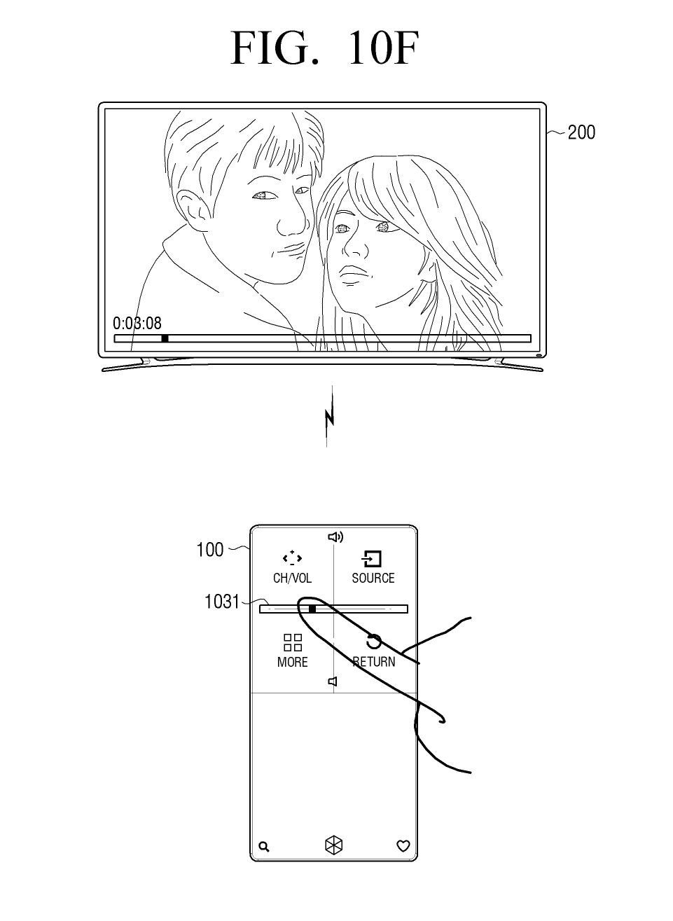

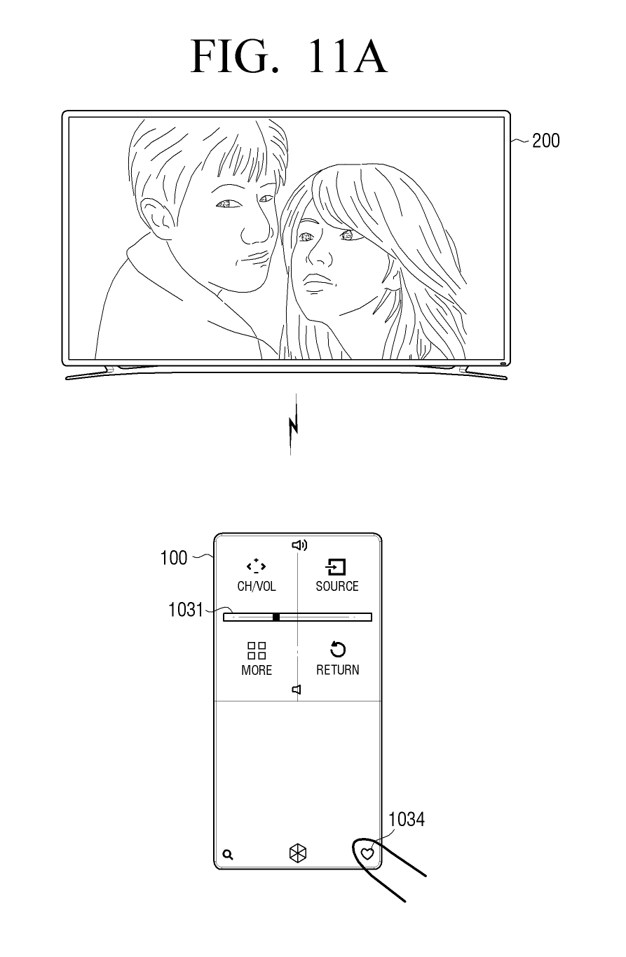

FIGS. 10A to 10F are views provided to explain operation of the user terminal apparatus according to another embodiment.

As illustrated in FIG. 10A, when pushing the confirm button of the fifth sub area 415 of the user terminal apparatus 100 while specific contents 1010 is selected by the select GUI 31 in the electronic apparatus 200, detailed descriptions of corresponding contents may be entered as illustrated in FIG. 10B.

As illustrated in FIG. 10B, when pushing the confirm button of the fifth sub area 415 while the select GUI 31 is placed on specific sub item 1012 of corresponding contents, a screen corresponding to the selected sub item 1012 may be provided. For example, a reproducing screen of corresponding contents may be provided as illustrated in FIG. 10C.

In this case, the UI screen of the user terminal apparatus 100 may be modified so as to correspond to status of the electronic apparatus 200. For example, as illustrated in FIG. 10D, a reproducing bar 1031 indicating a reproducing status of contents may be displayed on the protrusion area which is formed toward the horizontal direction, and GUIs 1032, 1033 for adjusting the volume may be displayed on the protrusion area which is formed toward the vertical direction. Further, the menu item 632 to display the character inputting UI illustrated in FIG. 10B may be modified into menu item 1034 to display and provide favorites of contents.

Therefore, as illustrated in FIGS. 10E and 10F, a user may control the reproducing status of the contents by scrolling the protrusion area which is formed toward the horizontal direction. Further, adjusting the volume may be performed with the same methods illustrated in FIGS. 8A to 8C.

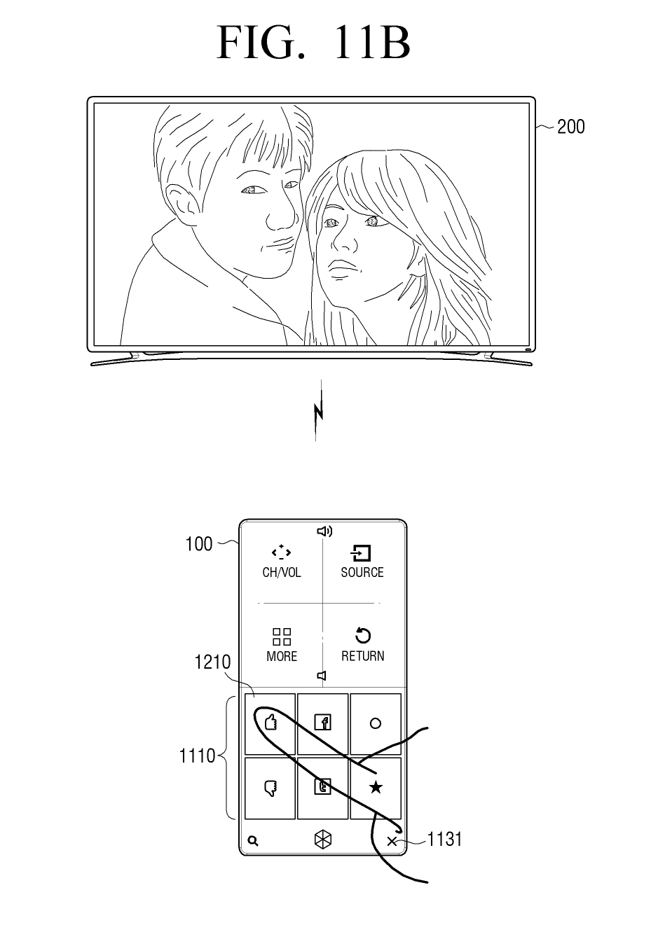

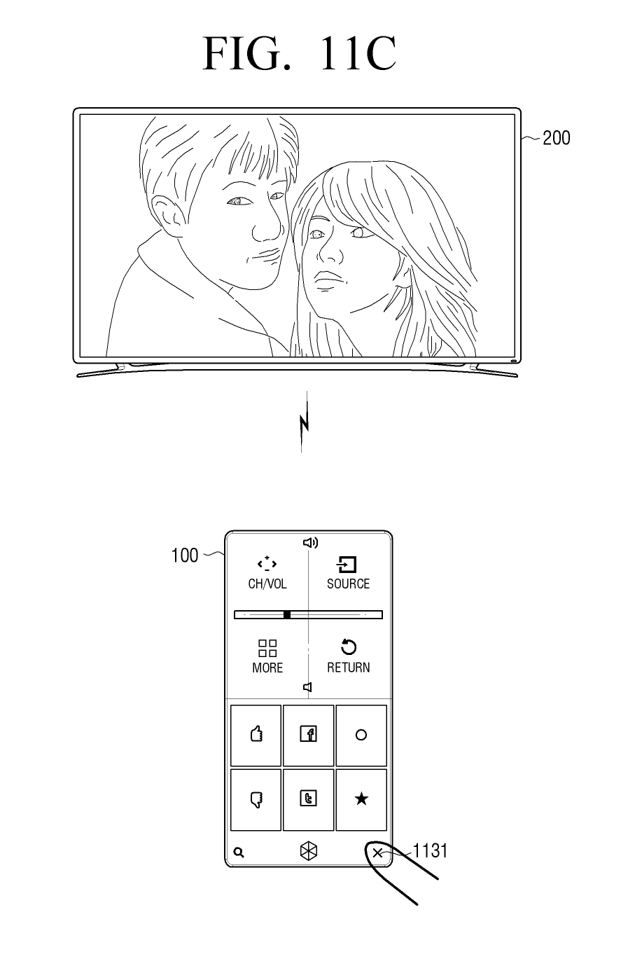

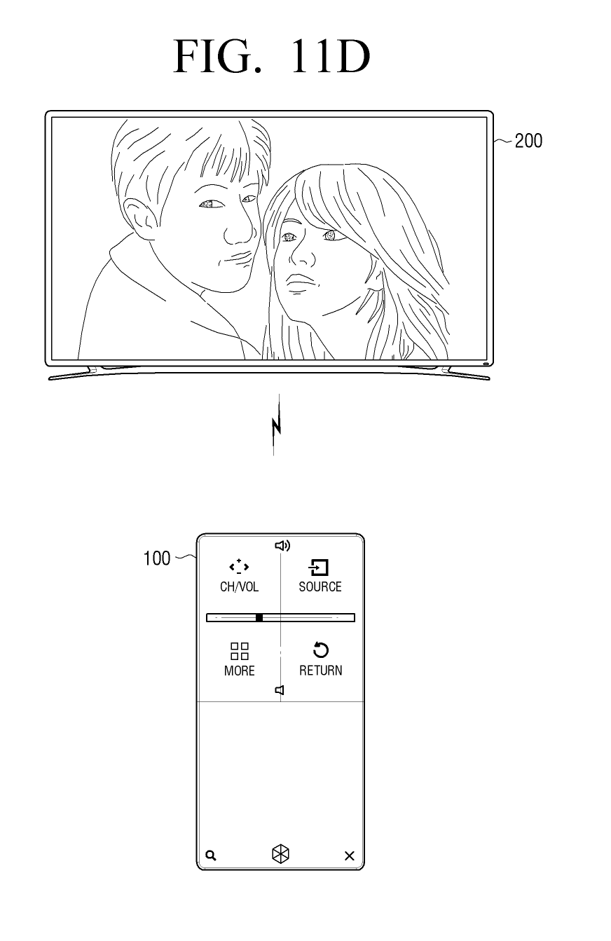

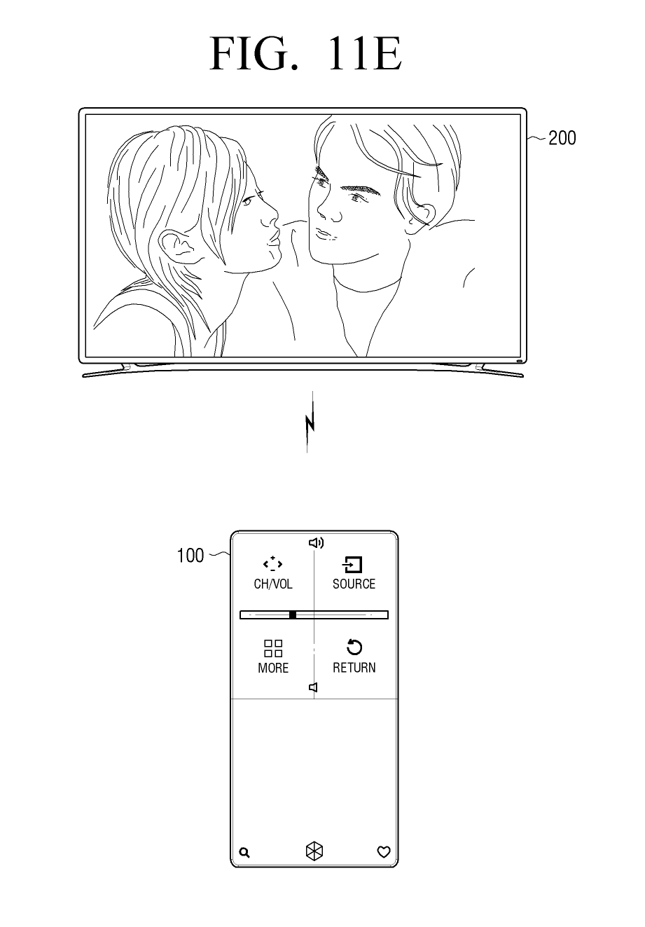

FIGS. 11A to 11E are views provided to explain an operation of the user terminal apparatus according to another embodiment.

When the menu item 1034 to display favorites of contents is selected as illustrated in FIG. 11A, favorite menu UI 1110 including various menu to display favorites of contents may be provided on the user terminal apparatus 100 as illustrated in FIG. 11B. In this case, the menu item 1034 to display favorites of contents may be modified into an exit menu item 1131 to exit from the corresponding favorite menu UI 1110.

When a specific menu is selected as illustrated in FIG. 11B, a function corresponding to the menu may be performed. For example, when the menu 1110 to establish corresponding contents to be favorite contents is selected, corresponding contents may be established to be favorite contents, and corresponding information may be used in recommending contents for a user and other users.

When the exit menu item 1131 is selected as illustrated in FIG. 11C, the favorite menu UI 1110 gradually disappears (not shown), and completely closes as illustrated in FIGS. 11D-11E.

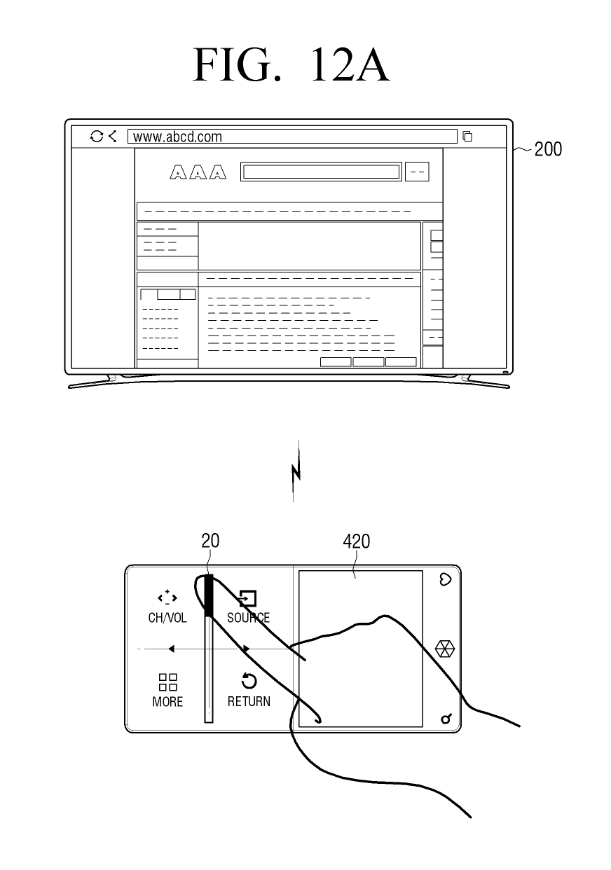

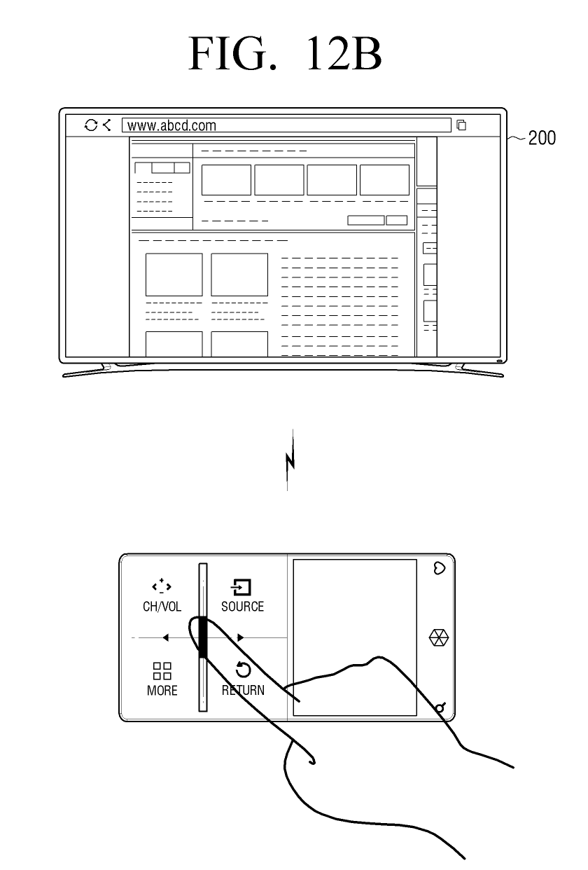

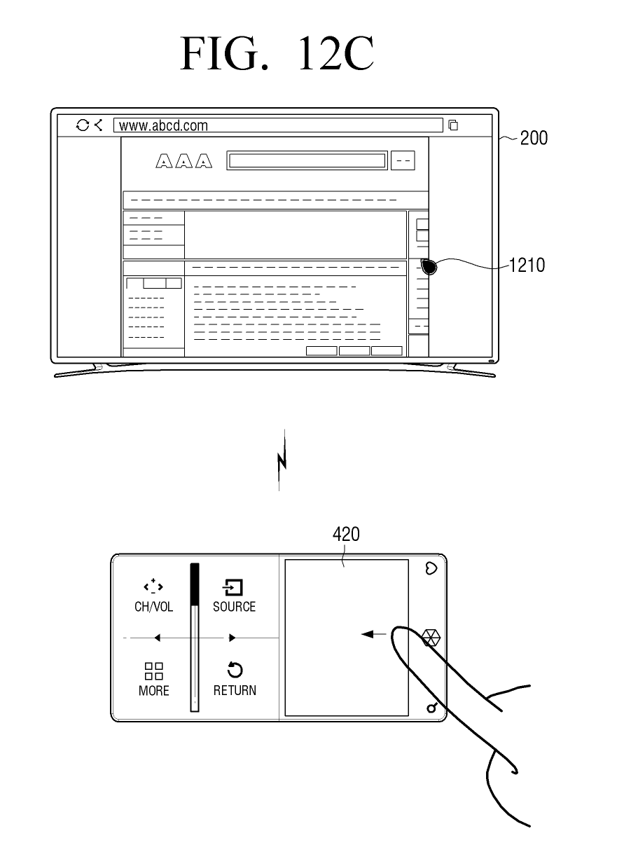

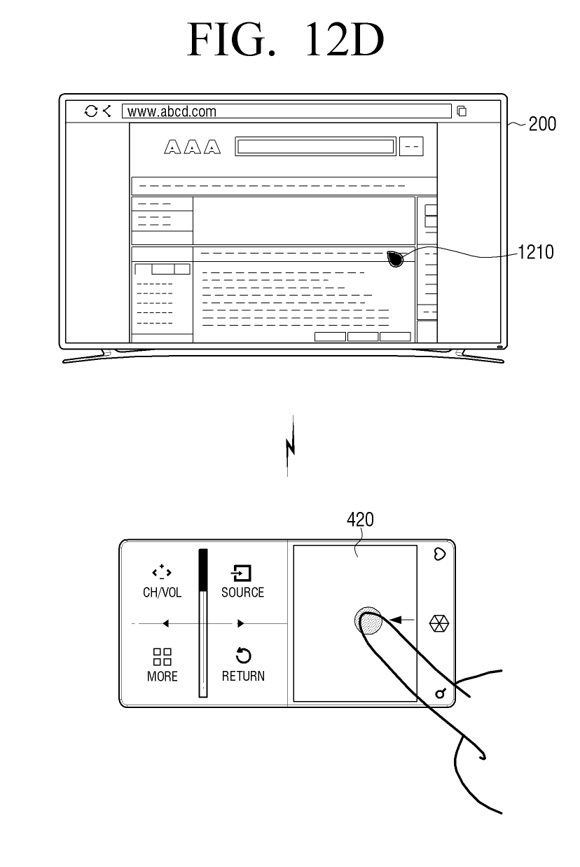

FIGS. 12A to 12D are views provided to explain an operation of the user terminal apparatus according to another embodiment.

As illustrated in FIGS. 12A to 12D, the user terminal apparatus 100 may provide a UI screen corresponding to the horizontal mode, instead of the vertical mode.

For example, when the electronic apparatus 200 is providing web pages as illustrated in FIG. 12A, the user terminal apparatus 100 may be used in the horizontal mode, instead of the vertical mode. In this case, items included in the UI screen provided from the horizontal mode may be modified to be directed corresponding to the user eyesight, and displayed. For example, items provided from the vertical mode may be rotated by 90° and displayed, as illustrated in FIG. 12A.

In this case, the protrusion 20 formed toward the upper-and-lower direction may be implemented to receive the input scroll manipulating commands in the horizontal mode, and the protrusion area may provide a GUI to indicate a scrolling situation. Further, the touch screen area 420 where the protrusion 20 is not provided may be implemented to receive the input user commands to adjust positions of the cursor 1210. Thus, the touch screen area 420 may operate as a touch pad receiving the input user touch interaction to adjust positions of the cursor 1210.

As illustrated in FIG. 12B, when the touch interaction regarding the protrusion 20 formed toward the upper-and-lower direction is input, the scroll function regarding web pages may be performed on the electronic apparatus 200.

As illustrated in FIGS. 12C-12D, positions of the cursor 1210 displayed on the electronic apparatus 200 may be adjusted through a touch interaction regarding the touch screen area 420 where the protrusion 20 is not provided.

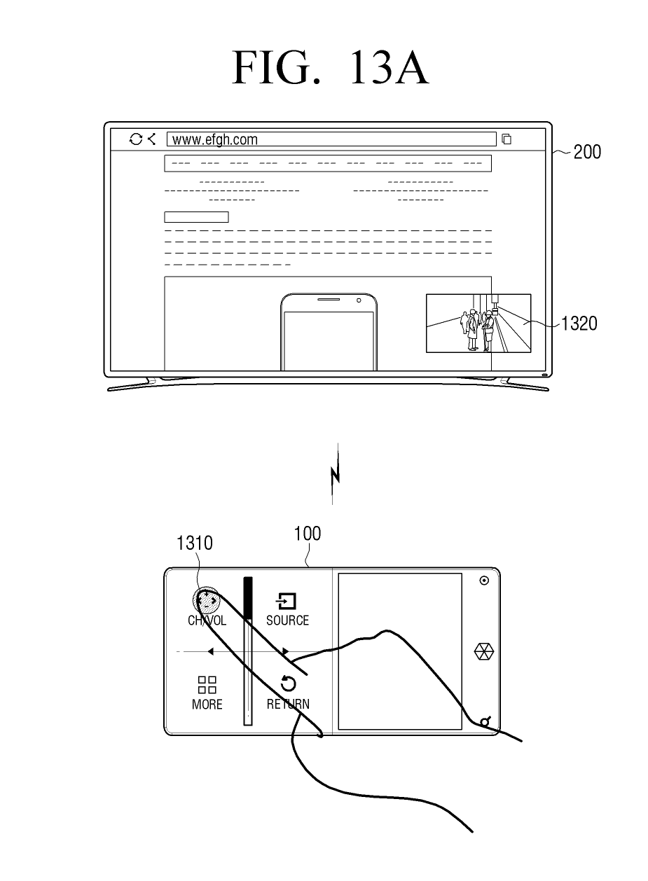

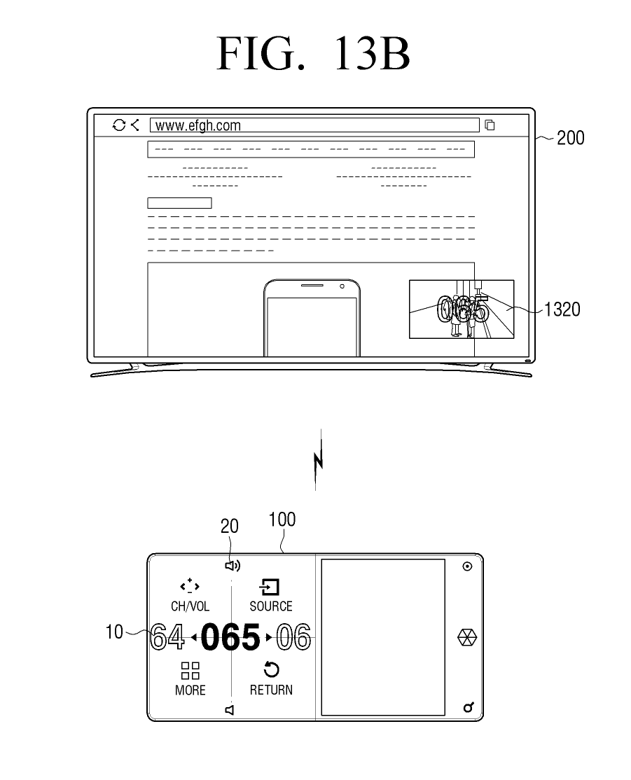

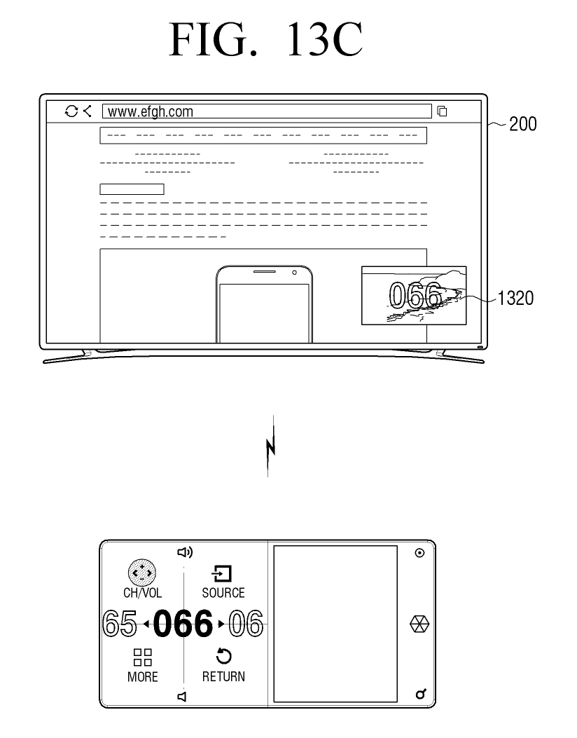

FIGS. 13A to 13C are views provided to explain an operation of the user terminal apparatus according to another embodiment.

As illustrated in FIGS. 13A to 13C, when the electronic apparatus 200 provides a main screen and a sub screen, the user terminal apparatus 100 may modify and provide a UI to control the main screen and the UI to control the sub screen at a real time according to a selection.

For example, as illustrated in FIG. 13A, when the main screen displays the web page and the sub screen 1320 such as a PIP screen displaying broadcasting contents, even if the user terminal apparatus 100 is operating in the proper horizontal mode for controlling the web page displayed on the main screen, the user terminal apparatus 100 may provide a UI to control channels and volumes proper for controlling the broadcasting contents displayed on the sub screen.

For example, as illustrated in FIG. 13A, when the channel/volume menu 1310 is selected while the user terminal apparatus 100 is operating in the horizontal mode, channel and volume UIs may be provided on the protrusions 10, 20 in the horizontal mode as illustrated in FIG. 13B. In particular, in the horizontal mode, the volume UI may be provided on the upper-and-lower direction protrusion 20, and the channel UI may be provided on the left-and-right direction protrusion 10. Although not illustrated in the drawings, when both the main screen and the sub screen 1320 provides broadcasting images, one screen that can be controlled by the channel and volume UIs 1310 may be selected among the main screen and the sub screen 1320.

As illustrated in FIG. 13C, zapping channels may be performed regarding broadcasting contents displayed on the sub screen 1320 provided in the horizontal mode through a touch interaction on the channel UI.

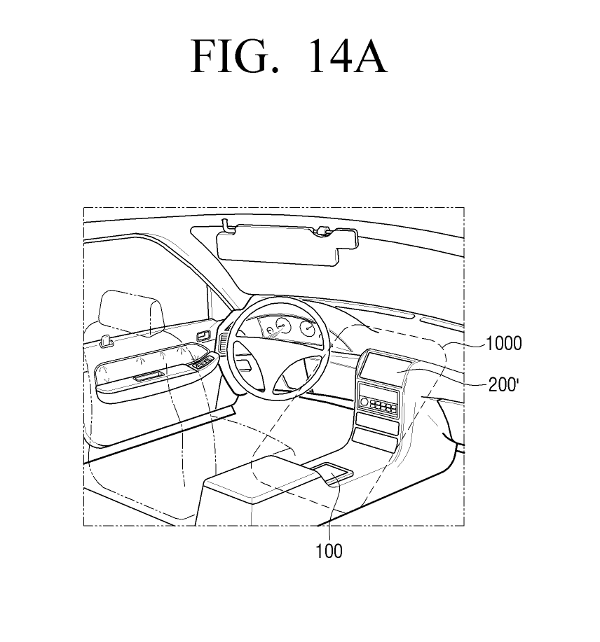

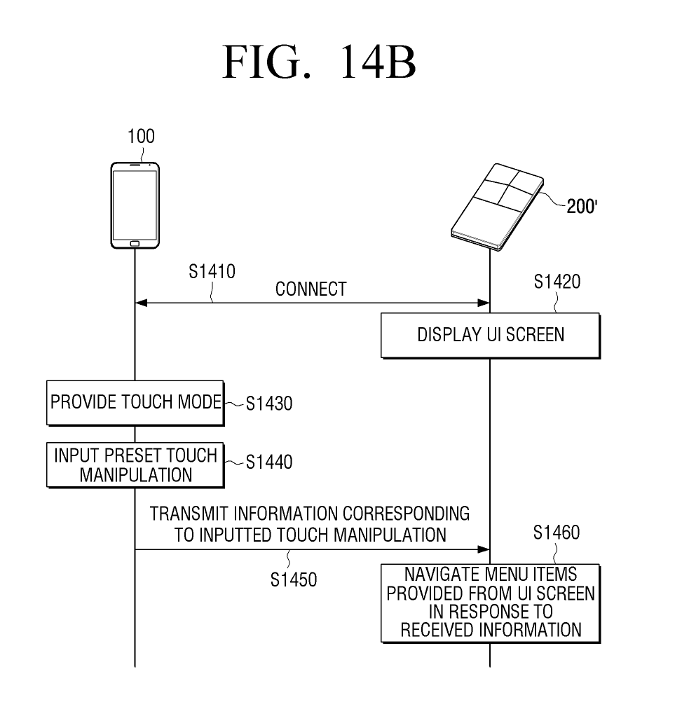

FIGS. 14A and 14B are views provided to explain a control method of the navigation apparatus according to another embodiment.

As illustrated in FIG. 14A, when the electronic apparatus 200′ is a navigation apparatus which is positioned in a center fascia screen device of a car, the user terminal apparatus 100 may receive the input user commands to adjust UI screens provided from the electronic apparatus 200′, and transmit the user commands to the electronic apparatus 200′.

In particular, the user terminal apparatus 100 may provide the touch mode to receive a touch interaction in order to navigate menu items displayed on a UI screen of the electronic apparatus 200′ when connecting, e.g., pairing with the electronic apparatus 200′. For example, the user terminal apparatus 100 may navigate depths of menu items included in a UI screen displayed on the electronic apparatus 200′ or navigate menu items provided from the uniform depths through the cross-shape protrusion. For example, the user terminal apparatus 100 may navigate depths of menu items through the upper-and-lower protrusion, and navigate menu items provided from the uniform depths through the left-and-right protrusion.

FIG. 14B is a sequence diagram explaining an operation of the user terminal apparatus 100 and the electronic apparatus 200′.

Referring to FIG. 14B, the user terminal apparatus 100 may connect with the electronic apparatus 200′ providing UI screen at S1410, and the UI screen may be displayed on the electronic apparatus 200′ at S1420.

At S1430, the user terminal apparatus 100 may provide the touch mode to manipulate the UI screen of the electronic apparatus 200′.

At S1440, when a preset touch interaction is input on the protrusion of the user terminal apparatus 100, corresponding information to the input touch interaction is transmitted to the electronic apparatus 200′ at S1450. In this case, the electronic apparatus 200′ may navigate menu items provided from UI screen according to the received information at S1460.

Since a user can remote-control a UI provided from the electronic apparatus 200′ without directly manipulating the electronic apparatus 200′, requested functions can be rapidly and precisely accessed without viewing the screen differently from the interaction to touch and select the related touch screen. Further, a user may use the user terminal apparatus 100 as a mobile phone, and use the apparatus 100 as a remote controlling device by connecting the electronic apparatus 200′ when riding a car. Thus, user convenience can be enhanced.

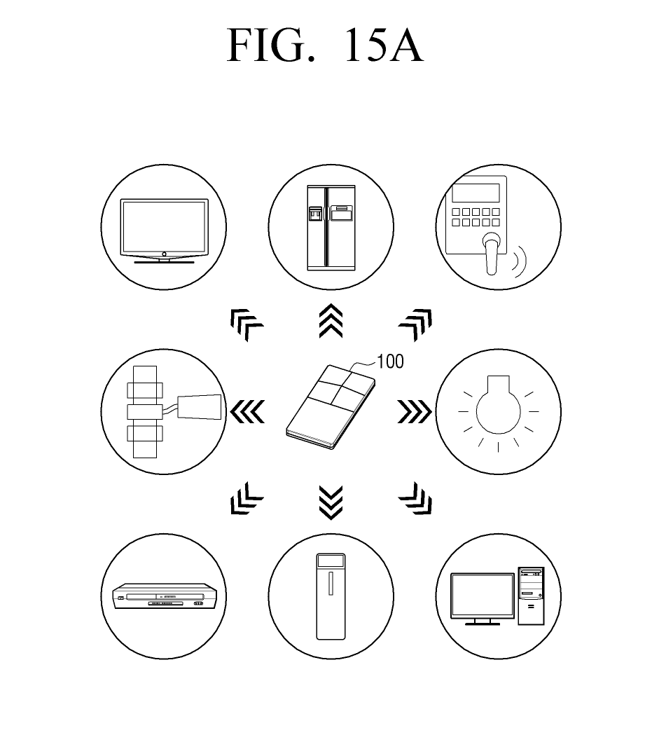

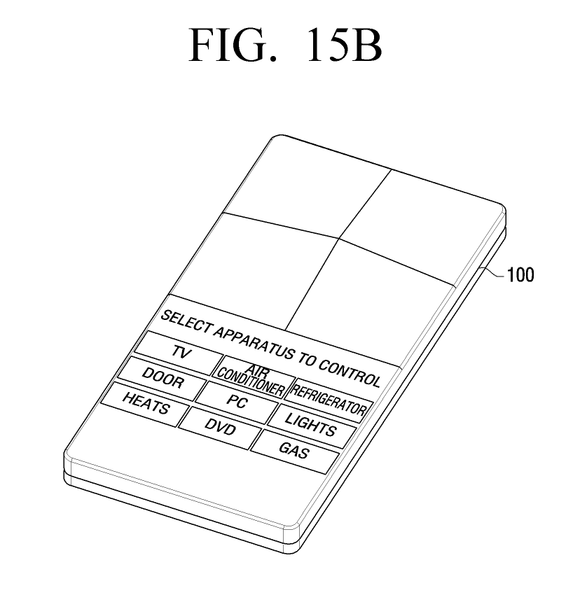

FIGS. 15A and 15B are views provided to explain the control method of an external apparatus according to another embodiment.

As illustrated in FIG. 15A, the controlled apparatus by the user terminal apparatus 100 may be various devices. For example, various devices within a home network may be controlled by the flexible display apparatus 100.

Therefore, as illustrated in FIG. 15B, a menu UI to select the controlled apparatus may be provided in the user terminal apparatus 100.

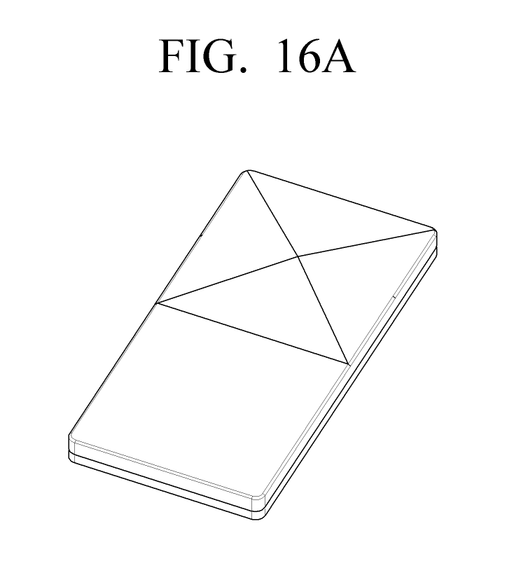

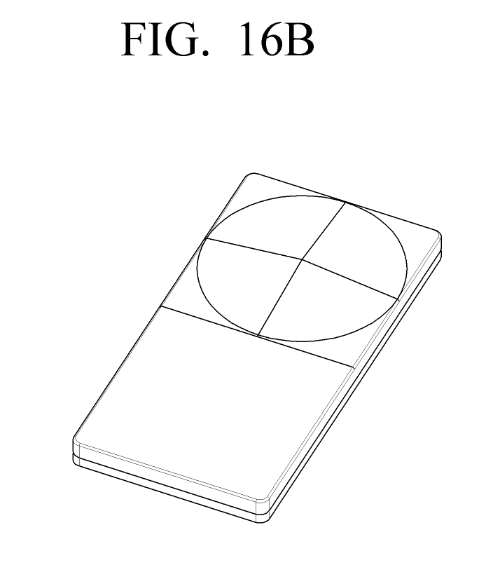

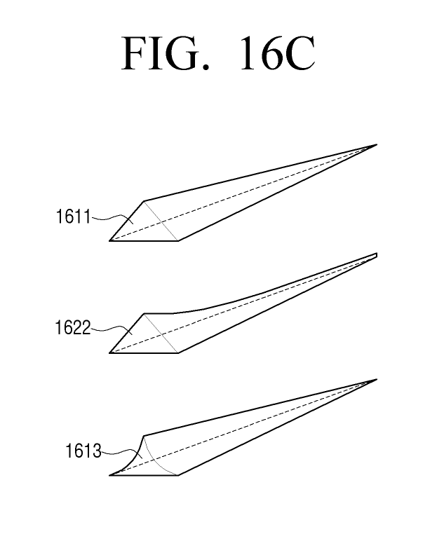

FIGS. 16A and 16B are diagrams describing shapes of the protrusion according to various embodiments.

As illustrated in FIG. 16A, the protrusion may a format in which two diagonals are crossed with each other. For example, the protrusion in a diagonal shape may be used in a game manipulation requesting the scrolling toward the diagonal direction which moves an object toward the diagonal direction, or in receiving the input touch interaction in cases requesting similar manipulations to the above.

As illustrated in FIG. 16B, the protrusion may be a format in which the circular protrusion is additionally provided on the exterior area of the cross-shape protrusion. For example, the circular protrusion provided on the exterior area of the cross-shape protrusion may be used in a game manipulation such as a car driving games or in receiving the input touch interaction in cases requesting similar manipulations to the above.

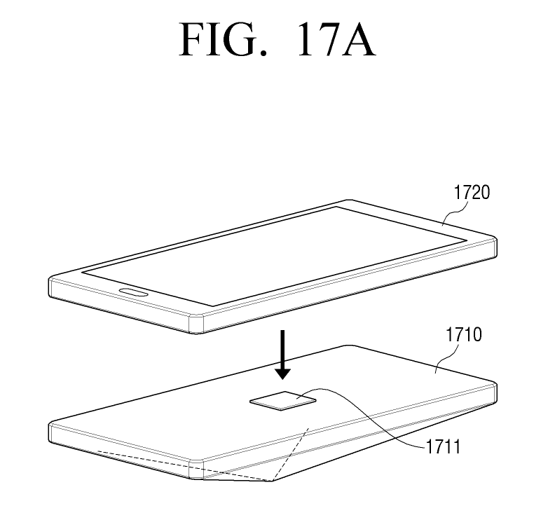

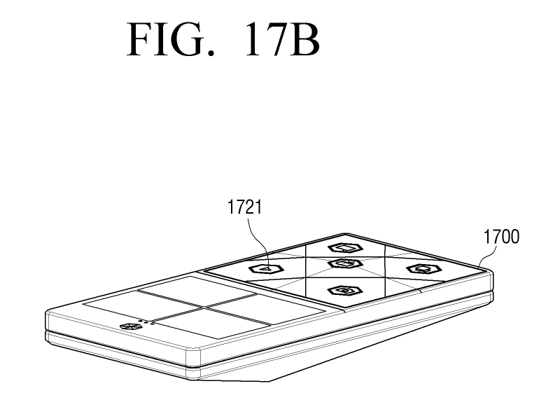

FIGS. 17A and 17B are views provided to explain functions of the support according to another embodiment.

As illustrated in FIG. 17A, when the support 1710 according to an embodiment is attached to the other user terminal apparatus 1720, the support 1710 may automatically activate the remote controlling function as illustrated in FIG. 17B.

As illustrated, a software module for the remote controlling function stored in a NFC tag provided in the support 1710 may be transmitted to the other user terminal apparatus 1720 and automatically performed. Thus, the remote controlling function may be activated. In this case, as illustrated in FIG. 17B, an initial UI screen 1721 provided from the remote controlling function may be provided.

Therefore, in contrast to a loading operation that occurs whenever the remote application is downloaded and the application is loaded, the remote controlling function can be automatically activated with a simple method of attaching the back case cover.

The method providing UI according to an embodiment is performed by software applications which are directly used by a user on OS. Further, applications may be provided in the icon interface format on the screen of the user terminal apparatus 100 or the electronic apparatus 200. However, exemplary embodiments are not limited thereto.

As described above, the exemplary embodiments enhance user convenience because user requesting commands can be input only by tactile feelings without checking the screen. Further, more convenient remote controlling function can be provided because a UI screen corresponding to a status of an external apparatus are provided based on the physical guide.

The control method of the user terminal apparatus according to various embodiments may be implemented to be program codes that can run in a computer. The program codes may be provided to each server or each device so as to be stored in various non-transitory computer readable recording medium and implemented by the processor.

For example, the exemplary embodiments may provide a non-transitory computer readable recording medium storing programs which can perform the UI components constituting a UI screen corresponding to the modified display status based on the physical guide which guides a user interaction regarding UI screen, in response to display status of an external apparatus being modified.

Non-transitory computer readable recording medium indicates a medium which stores data semi-permanently and can be read by devices, not a medium storing data temporarily such as register, cache, or memory. In particular, the above various applications or programs may be stored and provided in a non-transitory computer readable recording medium such as CD, DVD, hard disk, Blu-ray disk, USB, memory card, or ROM.

Further, the foregoing exemplary embodiments and advantages are merely exemplary and are not to be construed as limiting the exemplary embodiments. The present teaching can be readily applied to other types of apparatuses. Also, the description of the exemplary embodiments is intended to be illustrative, and not to limit the scope of the claims.

What is claimed is:

1. A user terminal apparatus, comprising:
a user interface (UI) which comprises a physical guide which guides a user interaction regarding the UI; and
a controller configured to provide a UI screen which corresponds to a modified context based on the physical guide in response to a context of an external apparatus being modified, and transmit a signal to the external apparatus to control the external apparatus in response to a touch interaction being input through the physical guide.

2. The user terminal apparatus of claim 1, wherein the context of the external apparatus is at least one of a contents type displayed on the external apparatus, a plurality of functions provided from the external apparatus, and a display status of the external apparatus.

3. The user terminal apparatus of claim 1, wherein the user interface comprises a touch screen, and the physical guide is provided on a touch screen.

4. The user terminal apparatus of claim 1, wherein the controller is further configured to display a plurality of UI components which correspond to a plurality of functions controlled through the touch interaction, on an area which corresponds to the physical guide based on the context of the external apparatus.

5. The user terminal apparatus of claim 4, wherein the controller is further configured to display the UI components to control at least one of a plurality of first functions which correspond to a first display status on the area which corresponds to the physical guide in response to the external apparatus operating in the first display status, and display the UI components to control at least one of a plurality of second functions which correspond to a second display status on the area corresponding to the physical guide in response to the external apparatus operating in the second display status.

6. The user terminal apparatus of claim 4, wherein the physical guide is provided in a format having a preset orientation, and the controller is further configured to display the UI components to control the functions having a plurality of directional attributes which match with the preset orientation of the physical guide on the area which corresponds to the physical guide based on the context of the external apparatus.

7. The user terminal apparatus of claim 6, wherein the physical guide is provided in a format which comprises at least one protruded line with a preset orientation.

8. The user terminal apparatus of claim 1, wherein the controller is further configured to display at least one of a UI for zapping channels and a UI for adjusting a volume on an area which corresponds to the physical guide in response to the external apparatus receiving broadcasting contents, and transmit at least one of a plurality of channel zapping signals and a plurality of volume adjusting signals which correspond to a touch interaction status in response to the touch interaction being input through the physical guide.

9. The user terminal apparatus of claim 1, wherein the controller is further configured to transmit to the external apparatus a plurality of controlling signals which comprises at least one of a signal to convert a plurality of UI pages based on the context of the external apparatus, a signal to move an object; a signal to adjust a volume, a signal for zapping channels, a signal for scrolling manipulation, and a signal which indicates a progression on a progress bar.

10. The user terminal apparatus of claim 1, wherein the controller is further configured to provide the UI screen which corresponds to the modified context of the external apparatus based on at least one of received information from the external apparatus and received information from an external server.

11. The user terminal apparatus of claim 1, wherein the controller is further configured to provide the UI screen which corresponds to the modified context of the external apparatus based on information input through the user interface.

12. The user terminal apparatus of claim 1, wherein the controller is further configured to provide a controlling mode of a horizontal status according to the context of the external apparatus, modify a plurality of directions of items in the UI screen so as to correspond to the controlling mode of the horizontal status, and display the items.

13. The user terminal apparatus of claim 1, wherein the controller is further configured to control the user terminal apparatus so that a wallpaper screen is provided which comprises at least one widget, a plurality of idle applications, and a plurality of customized contents, in response to the user terminal apparatus operating in a stand-by mode, and an initial screen is provided which comprises a plurality of preset items, in response to a preset event.

14. The user terminal apparatus of claim 13, wherein the controller is further configured to display the initial screen which comprises the preset items in response to the preset event occurring in the stand-by mode, and transmit a signal to the external apparatus to provide a screen which corresponds to the preset items along with a signal to turn on the external apparatus in response to the preset items being selected.

15. The user terminal apparatus of claim 1, further comprising:
a support protruding from at least one direction from a lower side of the user terminal apparatus, the support being used as a mount,
wherein the support comprises a near field communication tag storing software module related to a remote controlling function, the support being separated from the user terminal apparatus, and the support automatically activating the remote controlling function of another user terminal apparatus in response to the support being attached to the another user terminal apparatus.

16. A control method of a user terminal apparatus, comprising:
displaying a user interface (UI) screen to control an external apparatus;
providing the UI screen which corresponds to a modified context based on a physical guide to guide a user interaction regarding the UI screen in response to a context of the external apparatus being modified; and
transmitting a signal to the external apparatus to control the external apparatus in response to a touch interaction being input through the physical guide.

17. The control method of claim 16, wherein the context of the external apparatus is at least one of a contents type displayed on the external apparatus, a plurality of functions provided from the external apparatus, and a display status of the external apparatus.

18. The control method of claim 16, wherein the providing the UI screen which corresponds to the modified context comprises displaying a plurality of UI components which correspond to a plurality of functions controlled through the touch interaction, on an area which corresponds to the physical guide based on the context of the external apparatus.

19. The control method of claim 18, wherein the providing the UI screen which corresponds to the modified context comprises displaying the UI components to control at least one of a plurality of first functions which correspond to a first display status on the area which corresponds to the physical guide in response to the external apparatus operating in the first display status, and displaying the UI components to control at least one of a plurality of second functions which corresponds to a second display status on the area which corresponds to the physical guide in response to the external apparatus operating in the second display status.

20. An electronic system, comprising:
an external apparatus; and
a user terminal apparatus configured to provide a UI screen to control the external apparatus, and which comprises a physical guide which guides a user interaction regarding the UI screen,
wherein the user terminal apparatus is configured to provide the UI screen which corresponds to a modified context based on the physical guide in response to a context of the external apparatus being modified, and transmit a signal to the external apparatus to control the external apparatus in response to a touch interaction being input through the physical guide.
